(19) United States
(12) Patent Application Publication
(10) Pub. No.: US 2025/0296873 A1
(43) Pub. Date: Sep. 25, 2025

(54) FOLDABLE GLASS ELEMENT AND STACK ASSEMBLY COMPRISING THE SAME

(71) Applicants: Schott AG, Mainz (DE); SCHOTT Glass Technologies (Suzhou) Co. Ltd., Suzhou (CN)

(72) Inventors: Ning Da, Suzhou (CN); Wei Xiao, Shanghai (CN); Feng He, Suzhou (CN); Holger Wegener, Alfeld (DE)

(73) Assignees: Schott AG, Mainz (DE); SCHOTT Glass Technologies (Suzhou) Co. Ltd., Suzhou (CN)

(21) Appl. No.: 18/863,130

(22) PCT Filed: May 5, 2022
(86) PCT No.: PCT/CN2022/090857

§ 371 Date: Nov. 5, 2024

(51) Int. Cl. C03C 15/00

(52) U.S. Cl. CPC C03C 15/00

(57) ABSTRACT

The present invention relates to a flexible glass element and to a stack assembly comprising the glass element. The invention also relates to a method of producing the glass element or stack assembly comprising the same.

Also, the next generation foldable display models could feature even more than one fold area. Popular solutions are for instance the so-called S- or G-fold displays. The respective cover glasses will have to feature two fold regions, which will have to bend in two different bending radii. Additionally, one of the main surfaces and part of one bending region will be on the unprotected outside of the device. In this case, the exposed fold area will be especially vulnerable, as the glass is under tensile stress in its folded state. For these foldable displays, differential glass thicknesses are even more important.

Having slimmed or structured fold regions in such display stacks can be disadvantageous, since the abrupt thickness changes in the cover glass or the structured parts can provide challenges for the optical properties of the glass. Both thinned regions and structured regions have to be filled with an appropriate index matching polymer filler, so that the steps in the thickness or the through holes are not visible. Finally, sharp transition areas from thicker to thinner glass and back can in the worst case become predetermined breaking points. Similarly, delicate structured areas can also be prone to breakage. Having those in an exposed area of a device can create stability issues for the display.

### SUMMARY OF THE INVENTION

The object of the present invention is therefore to provide a glass element and a stack assembly comprising the glass element suitable for above mentioned foldable devices, having at least one fold area and advanced impact resistance (in for instance pen drop resistance tests) paired with necessary bendability. Further, an object of the present invention is to provide different production methods that allow manufacturing of above described glass elements with different technical approaches.

The solution to above described challenges is presented in the present invention in form of a glass element having homogeneous thickness transitions not only in the fold areas but also in the plane display areas. The thickness profile of a glass element of the present invention may in particular follow a continuous function without any abrupt changes in thickness values.

One embodiment of the present invention, resembles a glass element for a dual-fold (S-fold) display having a wedge-shaped thickness profile, transitioning from a maximal thickness (in the exposed main surface of the display) via an out-folding region (with a larger bending radius) to an in-folded display area with a narrower bending radius and two protected (in the folded state) main surfaces (see FIGS. 1A and 1D).

For a single-fold display another embodiment could resemble a glass element having a thickness profile with a waist-having two thicker outer regions, resembling the main surfaces, and a thinner mid-section, resembling the fold region (see FIG. 3A). A reversed thickness profile, a belly shaped glass, with a thick mid-section and two thinner outer sections, could resemble another embodiment suitable for a so-called “Gate fold” display assembly (see FIGS. 1B, 1E and 3B).

More complex structure would be a glass element with an undulating contour on one surface, resembling a glass element for multiple folds, such as “M/W” or even more folds (see FIGS. 1C and 1F) or a glass element where one side of it can be rolled up, while the other side can stay either straight or be additionally folded (see FIG. 2).

The distinctive feature of such a glass element would be, that the thickness variations take place not only in the fold regions, but smoothly transition from the main surfaces into the fold regions. The advantage of such a glass element would be that it does not have sharp transitions in thicknesses and therefore being less likely to create optical challenges. In addition, such a glass element will not need any or a substantially reduced amount of index-matched fillers and is therefore easier to be integrated into a display stack.

Furthermore, the glass element is very stable upon chemical toughening with reduced risk of waviness or breakage in view of the very smooth thickness transition.

Exemplary dimensions and bending radii for an S-fold glass element are depicted in FIG. 6 and the description thereof. A bending radius of such a glass element can be calculated as follows: For each bending axis with a bending radius of R, within a width of 4.378*R (along the direction perpendicular to the bending axis; not parallel), the glass element should preferably have an average thickness t_{avg} as shown in the following formula, wherein E is the Young's modulus of the glass:

$${t}_{avg} \leq \frac{3000 MPa * R}{1.198 * E}$$

Thicknesses of these types of glass elements can vary from 10 μm at the thinnest to 400 μm at the thickest sections. The total thickness variation (TTV=maximum thickness-minimum thickness) of such glass elements therefore varies from 10 to 390 μm.

The local thickness variation (LTV) is determined as the difference of largest thickness LT and smallest thickness ST of the glass element along a measuring path of 4 mm. Thus, the LTV is given for a particular measuring path of 4 mm so that there are different local thickness variations LTVᵢ depending on the positioning of the measuring path on the glass element. The measuring path may be positioned on the glass element in any orientation. The different LTVᵢ values are determined as LTVᵢ=LTᵢ-ST, with i=1, 2, . . . , n (wherein n is number of potentially possible different measuring paths of 4 mm on the glass element). The maximum local thickness variation (LTVₘₐₓ) of the glass element is the largest of all LTVᵢ values of the glass element. The minimum local thickness variation (LTVₘᵢₙ) of the glass element is the smallest of all LTVᵢ values of the glass element having a measuring path oriented in parallel to the measuring path underlying LTVₘₐₓ. In general, the orientation of a measuring path may be described based on three spatial directions x, y and z, wherein x and y correspond to the directions of the length and width of the glass element, respectively, and wherein z corresponds to the direction of the thickness of the glass element. The measuring path underlying LTVₘᵢₙ being parallel to the measuring path underlying LTVₘₐₓ refers to a parallel orientation in x- and y-direction. The orientation in z-direction may differ.

Notably, the edges of the glass element may have varying geometrical properties, for example due to chamfer structures. Therefore, the edge regions are preferably excluded from determining TTV and LTV values. Preferably, TTV and/or LTV refer to thicknesses of the glass element that are spaced apart from the edges of the glass element by at least 0.5 mm. Thus, for example smaller thicknesses at the edges due to chamfer structures are not taken into account for determination of the minimum thickness tₘᵢₙ of the glass element. Rather, tₘᵢₙ is the minimum thickness of the glass element at a distance of at least 0.5 mm from the edges. Likewise, the measuring paths of 4 mm for determining the LTV do preferably not include any position being closer to the edges than 0.5 mm.

### BRIEF DESCRIPTION OF THE DRAWINGS

In the drawings:

FIGS. 1A, 1B, and 1C schematically show glass elements according to different embodiments of the present invention;

FIGS. 1D, 1E, and 1F schematically show the glass elements of FIGS. 1A, 1B and 1C, respectively, in potential folded states;

FIG. 2 schematically shows another embodiment in which the glass element can be rolled up on one side of it;

FIGS. 3A and 3B schematically show a method of producing a glass element of the invention by hot-forming via slit down draw;

FIGS. 4A, 4B, and 4C schematically show etching techniques that can be applied for obtaining glass elements of the present invention;

FIG. 5A schematically shows producing a glass element having a thickness profile of the invention with a CNC tool;

FIGS. 5B and 5C show that the thickness profile of the glass element can be further modified by etching as indicated by the arrows;

FIGS. 6A and 6B schematically show the cross-section of a glass element of the invention having a wedge-shaped thickness profile;

FIGS. 7A and 7B are schematic representations of the set-up of the ball-on-ring test not drawn to scale;

FIG. 8 is a picture obtained by an interferometer of a wedge-shaped glass element of the invention;

FIG. 9 schematically shows the profile of a glass element comprising a first surface, a second surface and at least one edge connecting the first surface and the second surface;

FIG. 10 schematically illustrates a way of determining symmetry/asymmetry of a chamfer structure; and

FIG. 11 schematically shows another etching technique that can be applied for obtaining glass elements of the present invention.

### DETAILED DESCRIPTION OF THE INVENTION

The object is solved by the subject-matter provided according to the invention. The object is in particular solved by a glass element having a first surface and a second surface, wherein the glass element is characterized by the following thickness profile:
the glass element has a minimum thickness tₘᵢₙ and a maximum thickness tₘₐₓ, wherein tₘᵢₙ is at least 10 μm and tₘₐₓ is at most 400 μm,
the total thickness variation (TTV) of the glass element is in a range of from 10 μm to 390 μm, and
the maximum local thickness variation (LTVₘₐₓ) of the glass element over a measuring path of 4 mm is at most 69 μm.

The TTV may in particular be determined as tₘₐₓ-tₘᵢₙ. The thickness of the glass element at various locations may for example be measured with a micrometer.

First and second surface of the glass element are also referred to as the two main surfaces of the glass element.

The minimum thickness tₘᵢₙ may for example be in a range of from 10 to 100 μm, from 10 to 90 μm, from 10 to 80 μm, from 15 to 70 μm, from 15 to 60 μm, from 20 to 50 μm, from 20 to 45 μm, from 25 to 40 μm, from 25 to 35 μm, or from 25 to 30 μm. The minimum thickness tₘᵢₙ may for example be at least 10 μm, at least 15 μm, at least 20 μm, or at least 25 μm. The minimum thickness tₘᵢₙ may for example be at most 100 μm, at most 90 μm, at most 80 μm, at most 70 μm, at most 60 μm, at most 50 μm, at most 45 μm, at most 40 μm, at most 35 μm, at most 30 μm, or less than 30 μm, for example at most 25 μm.

The maximum thickness tₘₐₓ may for example be in a range of from 60 to 400 μm, from 60 to 350 μm, from 65 to 300 μm, from 65 to 250 μm, from 70 to 200 μm, from 70 to 150 μm, from 75 to 140 μm, from 75 to 130 μm, from 80 to 120 μm, from 80 to 110 μm, from 85 to 100 μm, or from 85 to 95 μm. The maximum thickness tₘₐₓ may for example be at least 60 μm, at least 65 μm, at least 70 μm, at least 75 μm, at least 80 μm, or at least 85 μm. The maximum thickness tₘₐₓ may for example be at most 400 μm, at most 350 μm, at most 300 μm, at most 250 μm, at most 200 μm, at most 150 μm, at most 140 μm, at most 130 μm, at most 120 μm, at most 110 μm, at most 100 μm, or at most 95 μm. In some embodiments, tₘₐₓ is at most 800 μm, at most 700 μm, at most 600 μm, at most 500 μm.

The ratio tₘₐₓ/tₘᵢₙ may for example be in a range of from 3:2 to 40:1, from 2:1 to 30:1, from 2:1 to 20:1, from 5:2 to 12:1, from 5:2 to 10:1, from 3:1 to 8:1, from 3:1 to 6:1, or from 7:2 to 5:1. The ratio tₘₐₓ/tₘᵢₙ may for example be at least 3:2, at least 2:1, at least 5:2, at least 3:1, or at least 7:2. The ratio tₘₐₓ/tₘᵢₙ may for example be at most 40:1, at most 30:1, at most 20:1, at most 12:1, at most 10:1, at most 8:1, at most 6:1, or at most 5:1.

The TTV may for example be in a range from 10 to 390 μm, from 10 to 310 μm, from 20 to 230 μm, from 20 to 150 μm, from 30 to 140 μm, from 40 to 125 μm, from 40 to 100 μm, from 50 to 80 μm, or from 50 to 70 μm. The TTV may for example be at least 10 μm, at least 20 μm, at least 30 μm, at least 40 μm, or at least 50 μm. The TTV may for example be at most 390 μm, at most 310 μm, at most 230 μm, at most 150 μm, at most 140 μm, at most 125 μm, at most 100 μm, at most 80 μm, or at most 70 μm.

The maximum local thickness variation (LTVₘₐₓ) of the glass element over a measuring path of 4 mm may for example be in a range of from 0.1 to 69 μm, from 0.2 to 50 μm, from 0.2 to 30 μm, from 0.5 to 15 μm, from 0.5 to 10 μm, from 0.75 to 5.0 μm, from 0.75 to 4.5 μm, from 1.0 to 4.0 μm, from 1.0 to 3.5 μm, from 1.25 to 3.0 μm, from 1.25 to 2.5 μm, or from 1.5 to 2.0 μm. The LTVₘₐₓ of the glass element over a measuring path of 4 mm may for example be at least 0.1 μm, at least 0.2 μm, at least 0.5 μm, at least 0.75 μm, at least 1.0 μm, at least 1.25 μm, or at least 1.5 μm. The LTVₘₐₓ of the glass element over a measuring path of 4 mm may for example be at most 69 μm, at most 50 μm, at most 30 μm, at most 15 μm, at most 10 μm, at most 5.0 μm, at most 4.5 μm, at most 4.0 μm, at most 3.5 μm, at most 3.0 μm, at most 2.5 μm, or at most 2.0 μm. In some embodiments, the LTVₘₐₓ of the glass element over a measuring path of 4 mm may for example be at most 10.0 μm, at most 9.0 μm, at most 8.0 μm, at most 7.0 μm, at most 6.0 μm, or at most 5.5 μm.

The minimum local thickness variation (LTVₘᵢₙ) of the glass element over a measuring path of 4 mm may for example be in a range of from 0.0 to 69 μm, from 0.0 μm to 30 μm, from 0.1 to 10 μm, from 0.2 to 5.0 μm, from 0.2 to 4.0 μm, from 0.5 to 3.0 μm, from 1.0 to 2.5 μm, or from 1.0 to 2.0 μm. The LTVₘᵢₙ of the glass element over a measuring path of 4 mm may for example be 0.0 μm. Thus, there may be areas of the glass element in which the thickness of the glass element does not change or does not substantially change over a measuring path of 4 mm. However, the LTVₘᵢₙ of the glass element over a measuring path of 4 mm may for example also be at least 0.1 μm, at least 0.2 μm, at least 0.5 μm, or at least 1.0 μm. The LTVₘᵢₙ of the glass element over a measuring path of 4 mm may for example be at most 69 μm, at most 30 μm, at most 10 μm, at most 5.0 μm, at most 4.0 μm, at most 3.0 μm, at most 2.5 μm, or at most 2.0 μm. In some embodiments, the LTVₘᵢₙ of the glass element over a measuring path of 4 mm may for example be at most 10.0 μm, at most 9.0 μm, at most 8.0 μm, at most 7.0 μm, at most 6.0 μm, or at most 5.5 μm.

The ratio LTVₘᵢₙ/LTVₘₐₓ may for example be in a range of from 0:1 to 1:1, from 1:100 to 99:100, from 1:50 to 99:100, from 1:20 to 49:50, from 1:10 to 49:50, from 1:5 to 19:20, 1:2 to 9:10, from 2:3 to 8:9, or from 4:5 to 7:8. The ratio LTVₘᵢₙ/LTVₘₐₓ may for example be 0:1 in case the glass element includes areas in which the thickness of the glass element does not change or does not substantially change over a measuring path of 4 mm. However, the ratio LTVₘᵢₙ/LTVₘₐₓ may for example also be at least 1:100, at least 1:50, at least 1:20, at least 1:10, at least 1:5, at least 1:2, at least 2:3, or at least 4:5. The ratio LTVₘᵢₙ/LTVₘₐₓ may for example be 1:1 or essentially 1:1. The closer the ratio LTVₘᵢₙ/LTVₘₐₓ gets to 1:1, the more homogeneous is the thickness variation throughout the glass element. In particular, a glass element having a wedge-shaped thickness profile may have a ratio LTVₘᵢₙ/LTVₘₐₓ of 1:1 or essentially 1:1. The ratio LTVₘᵢₙ/LTVₘₐₓ may for example be at most 1:1, at most 99:100, at most 49:50, at most 19:20, at most 9:10, at most 8:9, or at most 7:8. In some embodiments, the ratio LTVₘᵢₙ/LTVₘₐₓ is particularly low, for example at most 1:5, at most 1:10, or at most 1:100. In other embodiments, the ratio LTVₘᵢₙ/LTVₘₐₓ is particularly high, for example at least 9:10, at least 19:20, or at least 99:100.

The ratio LTVₘₐₓ/TTV may be given in the present disclosure as a percent value. Notably, LTVₘₐₓ is always given for a measuring path of 4 mm if not indicated otherwise. However, for ease of representation and better legibility the term “over a measuring path of 4 mm” may be omitted when referring to the ratio LTVₘₐₓ/TTV. For example, if LTVₘₐₓ is 1 μm over a measuring path of 4 mm and TTV is 100 μm, the present disclosure simply refers to the ratio LTVₘₐₓ/TTV being 1%.

The ratio LTVₘₐₓ/TTV may for example be in a range of from 0.1% to 50.0%, from 0.2% to 25.0%, from 0.5% to 10.0%, or from 1.0% to 5.0%. The ratio LTVₘₐₓ/TTV may for example be at least 0.1%, at least 0.2%, at least 0.5%, or at least 1.0%. The ratio LTVₘₐₓ/TTV may for example be at most 50.0%, at most 25.0%, at most 10.0%, or at most 5.0%.

The glass element of the invention may for example be a sheet or sheet-like element, in particular a round-shaped element, or an element of rectangular or squared shape having a length and a width. Both length and width of the glass element are preferably much larger as compared to the thickness of the element. For example, length and/or width may be at least 1 mm, at least 2 mm, at least 5 mm, at least 10 mm, at least 15 mm, at least 20 mm, at least 25 mm, at least 30 mm, at least 40 mm, or at least 50 mm. For example, length and/or width may be at most 500 mm, at most 400 mm, at most 300 mm, at most 200 mm, at most 150 mm, at most 125 mm, at most 100 mm, or at most 70 mm. The ratio of length and width may be 1:1 or more. In some embodiments, the glass element may have a notch, in particular for the front camera in smartphone applications, and/or holes or recesses for cameras and/or microphones or speakers.

In one aspect of the present invention, the glass element may have a length in a range of from 10 mm to 500 mm and/or a width in a range of from 5 mm to 400 mm, for example a length and/or a width in a range of from 10 to 400 mm, from 15 to 300 mm, from 20 to 200 mm, from 25 to 150 mm, from 30 to 125 mm, from 40 to 100 mm, or from 50 to 70 mm. The length and/or the width may for example be at least 5 mm, at least 10 mm, at least 15 mm, at least 20 mm, at least 25 mm, at least 30 mm, at least 40 mm, or at least 50 mm. The length and/or the width may for example be at most 500 mm, at most 400 mm, at most 300 mm, at most 200 mm, at most 150 mm, at most 125 mm, at most 100 mm, or at most 70 mm.

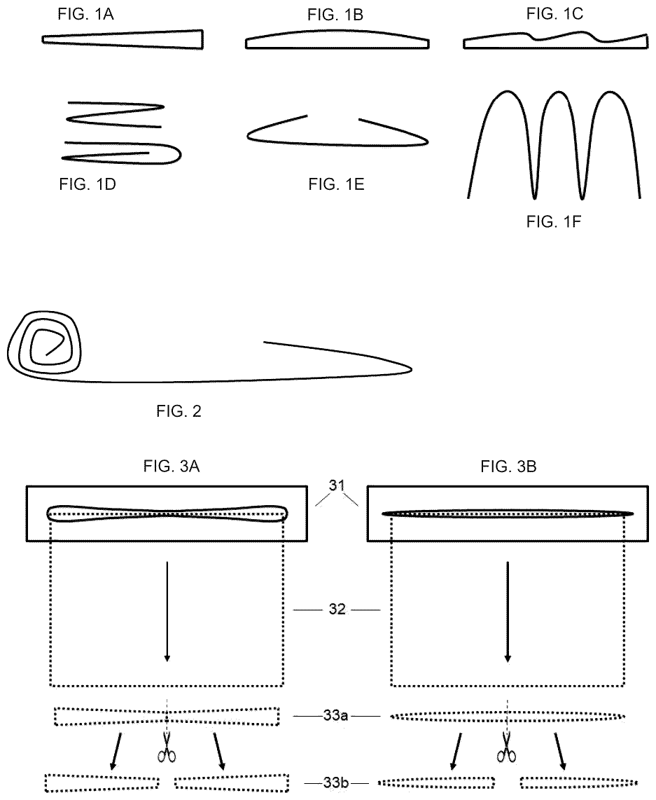

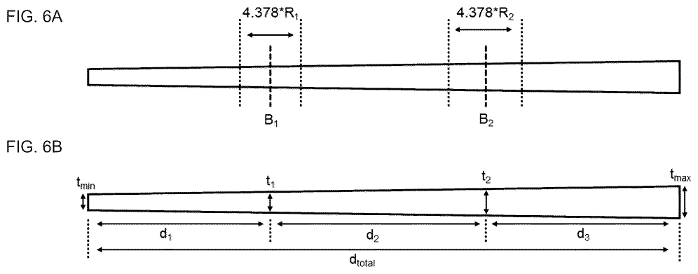

The glass element of the invention may in particular have a wedge-shaped thickness profile. A wedge-shaped thickness profile is exemplarily and schematically illustrated in FIGS. 1A and 6. A wedge-shaped thickness profile may be characterized by the glass element not including any regions at which the first surface and the second surface are parallel to each other. In other words, the transition from the maximum thickness tₘₐₓ to the minimum thickness tₘᵢₙ is preferably monotonous. Thus, maximum thickness tₘₐₓ and minimum thickness tₘᵢₙ of the glass element are located at opposite ends of the glass element, not in the center of the glass element.

Average surface roughness (Ra) is a measure of the texture of a surface. It is quantified by the vertical deviations of a real surface from its ideal form. Commonly amplitude parameters characterize the surface based on the vertical deviations of the roughness profile from the mean line. Ra is the arithmetic average of the absolute values of these vertical deviations. It can be determined according to DIN EN ISO 4287:2010-07.

Average surface roughness Ra is preferably determined with atomic force microscopy (AFM), in particular using BRUKER's Dimension Icon model. The tested area is preferably 2×2 μm² or more, or 10×10 μm² or more.

Preferably, the average surface roughness Ra of the first and/or second surface is at most 0.80 nm, at most 0.70 nm, at most 0.60 nm, at most 0.50 nm, at most 0.40 nm, at most 0.30 nm, more preferably at most 0.25 nm, more preferably at most 0.20 nm, more preferably at most 0.15 nm, in particular for a 2×2 μm² or 10×10 μm² area. The average surface roughness Ra of the first and/or second surface may for example be at least 0.05 nm, at least 0.08 nm, at least 0.10 nm, at least 0.11 nm, or at least 0.12 nm, in particular for a 2×2 μm² or 10×10 μm² area. The average surface roughness Ra of the first and/or second surface may for example be in a range of from 0.05 to 0.80 nm, from 0.05 to 0.70 nm, from 0.08 to 0.60 nm, from 0.08 to 0.50 nm, from 0.10 to 0.40 nm, from 0.11 to 0.30 nm, from 0.11 to 0.25 nm, from 0.12 to 0.20 nm, or from 0.12 to 0.15 nm, in particular for a 2×2 μm² or 10×10 μm² area.

The present invention relates to glass elements characterized by a thickness profile that provides a combination of very good impact resistance and very good bending properties. This is particularly advantageous for a use of the glass element in bendable electronic devices, such as smart phones, that need to be bendable and still withstand various external impacts without failure.

A measure for impact resistance is the pen drop height. The higher the pen drop height, the higher the impact resistance. The pen drop height is a breakage height that is determined in a pen drop test in which the glass element is attached with one surface to a 150 μm thick substrate, which consists of, from the side contacting the glass to the side contacting the marble stage, a 25 μm thick layer of pressure sensitive adhesive (PSA) material, a 50 μm thick layer of polyethylene (PE), another 25 μm thick layer of pressure sensitive adhesive (PSA), and another 50 μm thick layer of polyethylene (PE). Beneath the 150 μm thick substrate, there is a flat 10 cm thick marble stage, with polished smooth surface. The other surface of the glass element facing upwards (i.e. the surface whose pen drop height is actually tested) is then subsequently impacted with a 14 g ball point pen (Made by Chenguang) with the 0.5 mm diameter ball made from tungsten carbide, with increasing height from 5 mm until the glass breaks. The failure height is then recorded as the pen drop height.

The first and/or second surface of the glass element may comprise at least one impact resistant region characterized by an impact resistance corresponding to a pen drop height of at least 5 mm, at least 10 mm, at least 15 mm, at least 20 mm, at least 25 mm, at least 30 mm, at least 35 mm, at least 40 mm, at least 45 mm, at least 50 mm, at least 75 mm, at least 100 mm, at least 150 mm, at least 200 mm, at least 300 mm, at least 400 mm, or at least 500 mm. The first and/or second surface of the glass element may comprise at least one impact resistant region characterized by an impact resistance corresponding to a pen drop height of at most 10,000 mm, at most 5,000 mm, at most 4,000 mm, at most 3,000 mm, at most 2,000 mm, at most 1,500 mm, or at most 1,000 mm. In some embodiments, the first and/or second surface of the glass element may comprise at least one impact resistant region characterized by an impact resistance corresponding to a pen drop height of at most 500 mm, at most 450 mm, at most 400 mm, at most 350 mm, at most 300 mm, at most 250 mm, at most 200 mm, at most 150 mm, at most 100, or at most 75 mm. The first and/or second surface of the glass element may comprise at least one impact resistant region characterized by an impact resistance corresponding to a pen drop height of from 5 to 500 mm, from 10 to 450 mm, from 15 to 400 mm, from 20 to 350 mm, from 25 to 300 mm, from 30 to 250 mm, from 35 to 200 mm, from 40 to 150 mm, from 45 to 100 mm, or from 50 to 75 mm. In other embodiments, the first and/or second surface of the glass element may comprise at least one impact resistant region characterized by an impact resistance corresponding to a pen drop height in a range of from 75 to 10,000 mm, from 100 to 5,000 mm, from 150 to 4,000 mm, from 200 to 3,000 mm, from 300 to 2,000 mm, from 400 to 1,500 mm, or from 500 to 1,000 mm.

It is also possible to normalize the pen drop height to the thickness of the impact resistant region(s) of the glass element. A normalized pen drop height may be obtained as the ratio of the pen drop height (in μm) and the square of the average thickness of the corresponding impact resistant region(s) of the glass element (in μm²). For example, if a certain glass element comprise at an impact resistant region characterized by an impact resistance corresponding to a pen drop height of 10 mm (=10,000 μm) and the average thickness of the glass element in the respective impact resistant region is 50 μm, the normalized pen drop height can be obtained as 10,000 μm divided by 502 μm², resulting in a value of 4.0 per μm for the normalized pen drop height.

The first and/or second surface of the glass element may comprise at least one impact resistant region characterized by an impact resistance corresponding to a normalized pen drop height of at least 2.0 per μm, at least 2.5 per μm, at least 3.0 per μm, at least 3.5 per μm, at least 4.0 per μm, at least 4.5 per μm, at least 5.0 per μm, at least 5.5 per μm, at least 6.0 per μm, at least 6.5 per μm, at least 7.0 per μm, at least 7.5 per μm, at least 8.0 per μm, at least 8.5 per μm, at least 9.0 per μm, at least 9.5 per μm, at least 10.0 per μm, or at least 10.5 per μm. The first and/or second surface of the glass element may comprise at least one impact resistant region characterized by an impact resistance corresponding to a normalized pen drop height of at most 60.0 per μm, at most 50.0 per μm, at most 45.0 per μm, at most 40.0 per μm, at most 35.0 per μm, at most 30.0 per μm, at most 25.0 per μm, at most 20.0 per μm, at most 18.0 per μm, at most 16.0 per μm, at most 14.0 per μm, at most 12.0 per μm, or at most 11.0 per μm. The first and/or second surface of the glass element may comprise at least one impact resistant region characterized by an impact resistance corresponding to a normalized pen drop height in a range of from 2.0 to 60.0 per μm, from 2.5 to 60.0 per μm, from 3.0 to 60.0 per μm, from 3.5 to 60.0 per μm, from 4.0 to 60.0 per μm, from 4.5 to 60.0 per μm, from 5.0 to 50.0 per μm, from 5.5 to 45.0 per μm, from 6.0 to 40.0 per μm, from 6.5 to 35.0 per μm, from 7.0 to 30.0 per μm, from 7.5 to 25.0 per μm, from 8.0 to 20.0 per μm, from 8.5 to 18.0 per μm, from 9.0 to 16.0 per μm, from 9.5 to 14.0 per μm, from 10.0 to 12.0 per μm, or from 10.5 to 11.0 per μm.

The glass element may comprise at least one flexible region particularly suitable for withstanding tensile stresses occurring on the first and/or second surface upon bending of the glass element. This is reflected by the flexible region(s) having a particularly high ball-on-ring failure force and/or 2-point bending strength. Notably, the at least one flexible region may partially or entirely overlap with the at least one impact resistant region or alternatively there may be no overlap. For example, from 0% to 100% of the at least one flexible region such as at least 10%, at least 25%, at least 50%, at least 75%, at least 90%, at least 95%, at least 99% or 100% of the at least one flexible region and/or at most 99%, at most 95%, at most 90%, at most 75%, at most 50%, at most 25%, at most 10%, at most 5%, at most 1% or 0% of the at least one flexible region may also qualify as impact resistant region in the sense of the present invention. Likewise, from 0% to 100% of the at least one impact resistant region such as at least 10%, at least 25%, at least 50%, at least 75%, at least 90%, at least 95%, at least 99% or 100% of the at least one impact resistant region and/or at most 99%, at most 95%, at most 90%, at most 75%, at most 50%, at most 25%, at most 10%, at most 5%, at most 1% or 0% of the at least one impact resistant region may also qualify as flexible region in the sense of the present invention.

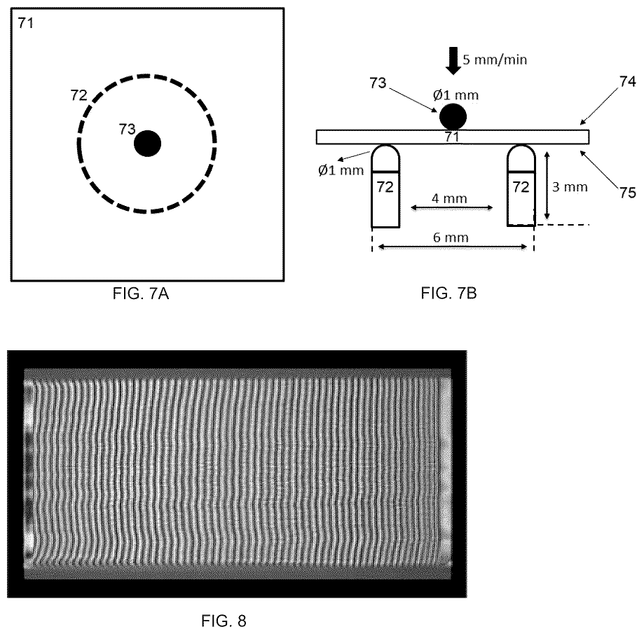

As schematically illustrated in FIG. 7, the ball-on-ring failure force may be tested by placing surface 75 of the glass element 71 on a steel ring 72, the ring 72 having an inner diameter of 4 mm and an outer diameter of 6 mm. The ring 72 is 3 mm deep, and the wall of the ring 72 is 1 mm thick with the tip of the wall having a semi-circle with a diameter of 1 mm as cross-section. For testing the ball-on-ring failure force, the edges of the glass element 71 are at least 20 mm away from the center of the ring 72. A tungsten carbide ball 73 having a diameter of 1 mm is pressed against the surface 74 of glass element 41 along the center axis of the ring 72, with a speed of 5 mm/min until the glass shatters. The force at failure is recorded as the ball-on-ring failure force.

Depending on which of the surfaces of the glass element 71 is contacted with the ring 72 or with the ball 73, respectively, the ball-on-ring failure force of the first surface or of the second surface of glass element 71 can be tested. The ball-on-ring test as described herein is adjusted for determining the ball-on-ring failure force of that particular surface of the glass element 71 that is in contact with the steel ring 72. For example, if the second surface of the glass element 71 is surface 75 being contacted with the steel ring 72 whereas the first surface of the glass element 71 is surface 74 being contacted with the ball 73, the output of the ball-on-ring test is the ball-on-ring failure force of the second surface. However, if the first surface of the glass element 71 is surface 75 being contacted with the steel ring 72 whereas the second surface of the glass element 71 is surface 74 being contacted with the ball 73, the output of the ball-on-ring test is the ball-on-ring failure force of the first surface. It is surface 75 of the glass element 71 that experiences tensile forces during the ball-on-ring test. Therefore, the output of the ball-on-ring test is the ball-on-ring failure force of surface 75.

However, when the present disclosure refers to the glass element comprising at least one flexible region characterized by a certain ball-on-ring failure force and/or by a certain 2-point bending strength, the disclosure does not differentiate between the two surfaces of the glass element if not indicated otherwise. Rather, the present disclosure refers to the ball-on-ring failure force and/or to the 2-point bending strength achieved at the first and/or second surface within the flexible region of the glass element if not indicated otherwise. Thus, if the ball-on-ring failure force and/or the 2-point bending strength is achieved at the first surface and/or at the second surface within a certain region of the glass element, the glass element comprises at least one flexible region characterized by the respective ball-on-ring failure force and/or 2-point bending strength if not indicated otherwise.

The glass element may comprise at least one flexible region characterized by a ball-on-ring failure force of at least 1.0 N, at least 2.0 N, at least 5.0 N, at least 7.5 N, at least 10.0 N, at least 12.5 N, at least 15.0 N, or at least 17.5 N. The glass element may comprise at least one flexible region characterized by a ball-on-ring failure force of at most 50.0 N, at most 45.0 N, at most 40.0 N, at most 35.0 N, at most 30.0 N, at most 25.0 N, at most 22.5 N, or at most 20.0 N. The glass element may comprise at least one flexible region characterized by a ball-on-ring failure force in a range of from 1.0 to 50.0 N, from 2.0 to 45.0 N, from 5.0 to 40.0 N, from 7.5 to 35.0 N, from 10.0 to 30.0 N, from 12.5 to 25.0 N, from 15.0 to 22.5 N, or from 17.5 to 20.0 N.

The particularly good bendability of the glass element of the invention is also reflected by the 2-point bending strength (2PB strength) being particularly high, in particular in the flexible region(s). For testing the 2PB strength, the glass element is placed as a U-shape between two parallel metal plates. The two plates are big enough to cover the whole glass element. Then one of the plate moves towards the other one while remaining parallel with a speed of 60 mm/min until the glass element breaks. The 2PB strength is calculated by:

σ=1.198 Ed/(D-d)

where σ is the calculated 2PB strength; E is the Young's modulus of the glass; d is the thickness of the glass element; D is the distance between the two plates at failure.

The output of the 2PB test is the 2PB strength of the surface of the glass element that represented the outer surface of the bend. For example, if the glass element was bent such that the second surface of the glass element was the outer surface of the bend whereas the first surface of the glass element was the inner surface of the bend, the output of the 2PB test is the 2PB strength of second surface of the glass element. However, as described above, when the present disclosure refers to the glass element comprising at least one flexible region characterized by a certain 2-point bending strength, the disclosure does not differentiate between the two surfaces of the glass element if not indicated otherwise. Rather, the present disclosure refers to the 2-point bending strength achieved at the first and/or second surface within the flexible region of the glass element if not indicated otherwise. Thus, if the 2-point bending strength is achieved at the first surface and/or at the second surface within a certain region of the glass element, the glass element comprises at least one flexible region characterized by the respective 2-point bending strength if not indicated otherwise.

The glass element may for example comprise at least one flexible region characterized by a 2PB strength of at least 1000 MPa, at least 1250 MPa, at least 1300 MPa, at least 1500 MPa, at least 1750 MPa, at least 2000 MPa, at least 2250 MPa, at least 2500 MPa, at least 2750 MPa, or at least 3000 MPa. The glass element may for example comprise at least one flexible region characterized by a 2PB strength of at most 10,000 MPa, at most 7500 MPa, at most 6750 MPa, at most 6000 MPa, at most 5000 MPa, at most 4500 MPa, at most 4000 MPa, at most 3750 MPa, at most 3500 MPa, or at most 3250 MPa. The glass element may for example comprise at least one flexible region characterized by a 2PB strength in a range of from 1000 to 10,000 MPa, from 1250 to 7500 MPa, from 1300 to 6750 MPa, from 1500 to 6000 MPa, from 1750 to 5000 MPa, from 2000 to 4500 MPa, from 2250 to 4000 MPa, from 2500 to 3750 MPa, from 2750 to 3500 MPa, or from 3000 to 3250 MPa.

The glass element may for example comprise at least one, at least two, at least three, or at least four flexible regions. The glass element may for example comprise at most fifty, at most twenty, at most ten, or at most five flexible regions. The number of flexible regions may for example be from 1 to 50, from 2 to 20, from 3 to 10, or from 4 to 5. For example, in case of a rollable glass element the whole rollable region may be regarded as one flexible region.

The glass element may for example comprise at least one flexible region characterized by an absence of failure when the glass element is held for 60 minutes at a bending radius R of 5.0 mm at the center of the flexible region, in particular at a temperature of 25° C. and a relative humidity of 40%.

The glass element may for example comprise at least one flexible region characterized by an absence of failure when the glass element is held for 60 minutes at a bending radius R of 1.5 mm at the center of the flexible region, in particular at a temperature of 25° C. and a relative humidity of 40%.

The glass element may for example comprise
at least a first flexible region characterized by an absence of failure when the glass element is held for 60 minutes at a first bending radius R₁ of 1.5 mm at the center of the first flexible region, and
at least a second flexible region characterized by an absence of failure when the when the glass element is held for 60 minutes at a second bending radius R₂ of 5.0 mm at the center of the second flexible region.

The width of the flexible region(s) may in particular be defined as 4.378*R along the direction perpendicular to the bending axis with the bending axis forming the center of the flexible region(s). The average thickness t_{avg} of the glass element over the width of the flexible region(s) may for example be as follows:

$${t}_{avg} \leq \frac{3000 MPa * R}{1.198 * E}$$

wherein R is the bending radius and wherein E is the Young's modulus of the glass.

The warp may for example be measured by placing the glass element on a flat surface, then the largest distance between the bottom surface of the glass element and the flat surface is recorded as warp. The warp may for example be measured by a set of feeler gauge, in particular with a resolution of 0.01 mm. As used herein, the term “warp” refers to the warp of the glass element in an unfolded, unbent state if not indicated otherwise.

The glass element of the invention may for example have a warp of at least 0.005 mm, at least 0.01 mm, at least 0.02 mm, at least 0.03 mm, at least 0.05 mm, at least 0.1 mm, at least 0.5 mm, at least 1.0 mm, or at least 2.0 mm. The glass element of the invention may for example have a warp of at most 10.0 mm, at most 7.5 mm, at most 5.0 mm, at most 2.5 mm, at most 2.0 mm, at most 1.5 mm, at most 1.0 mm, at most 0.5 mm, at most 0.2 mm, or at most 0.1 mm. The glass element of the invention may for example have a warp in a range of from 0.005 to 10.0 mm, from 0.01 to 7.5 mm, from 0.02 to 5.0 mm, from 0.03 to 2.5 mm, from 0.05 to 2.5 mm, from 0.1 to 10.0 mm, from 0.5 to 7.5 mm, from 1.0 to 5.0 mm, or from 2.0 to 2.5 mm, or from 0.005 to 2.0 mm, from 0.01 to 1.5 mm, from 0.02 to 1.0 mm, from 0.01 to 0.1 mm, from 0.02 to 0.5 mm, or from 0.005 to 0.2 mm. This warp is also referred to as absolute warp and indicates the warp of the glass element.

However, it is also possible to determine the relative warp of a glass element, in particular the area-relative warp and/or the length-relative warp.

The warp of the glass element may for example be indicated normalized to the surface area of one of the two main surfaces of the glass element (area-relative warp). Both main surfaces of the glass element generally have the same surface area or about the same surface area so that the warp can be normalized to any one of the two main surfaces with the same result. For example, each of the two main surfaces of a glass element having a length of 50 mm and a width of 30 mm has a surface area of 30×50 mm²=1500 mm². Likewise, each of the two main surfaces of a glass element having a length of 125 mm and a width of 40 mm has a surface area of 125×40 mm²=5000 mm². If such a glass element with a surface area of 5000 mm² of each of the two main surfaces had a warp of 2.0 mm (=2000 μm), the area-relative warp would be 2000 μm divided by 5000 mm², i.e. 0.4 μm per mm².

The glass element of the invention may have an area-relative warp of at least 1 nm per mm², at least 2 nm per mm², at least 5 nm per mm², at least 10 nm per mm², at least 20 nm per mm², at least 50 nm per mm², at least 100 nm per mm², or at least 250 nm per mm². The glass element of the invention may have an area-relative warp of at most 5.0 μm per mm², at most 2.5 μm per mm², at most 1.5 μm per mm², at most 1.0 μm per mm², at most 500 nm per mm², at most 200 nm per mm², at most 100 nm per mm², or at most 50 nm per mm². The glass element of the invention may have an area-relative warp in a range of from 0.02 to 5.0 μm per mm², from 0.05 to 2.5 μm per mm², from 0.10 to 1.5 μm per mm², from 0.25 to 1.0 μm per mm², from 1 to 500 nm per mm², from 2 to 200 nm per mm², from 5 to 100 nm per mm², or from 10 to 50 nm per mm².

The warp of the element may also be indicated normalized to the longest length of one of the two main surfaces of the glass element (length-relative warp). Both main surfaces of the glass element generally have the same longest length or about the same longest length so that the warp can be normalized to any one of the two main surfaces with the same result. For glass elements having main surfaces with round shape, the longest length is the diameter thereof. For glass elements having main surfaces with rectangular shape, the longest length is the diagonal thereof. For example, each of the two main surfaces of a glass element having a length of 50 mm and a width of 30 mm has a longest length of square root (302 mm²+502 mm²)˜ 58.3 mm. Likewise, each of the two main surfaces of a glass element having a length of 125 mm and a width of 40 mm has a longest length of square root (1252 mm²+402 mm²)=131.25 mm. If such a glass element with a longest length of 131.25 mm of each of the two main surfaces had a warp of 2.0 mm (=2000 μm), the length-relative warp would be 2000 μm divided by 131.25 mm, i.e. about 15.2 μm per mm.

The glass element of the invention may have a length-relative warp of at least 1 nm per mm, at least 2 nm per mm, at least 5 nm per mm, at least 10 nm per mm, at least 20 nm per mm, at least 50 nm per mm, at least 100 nm per mm, or at least 250 nm per mm. The glass element of the invention may have a length-relative warp of at most 50.0 μm per mm, at most 40.0 μm per mm, at most 30.0 μm per mm, at most 20.0 μm per mm, at most 10.0 μm per mm, at most 5.0 μm per mm, at most 2.0 μm per mm, or at most 1.0 μm per mm. The glass element of the invention may have a length-relative warp in a range of from 20 nm to 50.0 μm per mm, from 50 nm to 40.0 μm per mm, from 100 nm to 30.0 μm per mm, from 250 nm to 20.0 μm per mm, from 1 nm to 1.0 μm per mm, from 2 nm to 2.0 μm per mm, from 5 nm to 10.0 μm per mm, or from 10 nm to 5.0 μm per mm.

The glass elements of the present invention are not restricted to certain glass compositions. However, some glass compositions are particularly advantageous. In an embodiment, the glass may be a silicate glass, such as alumosilicate glass, lithium-aluminum-silicate glass, or borosilicate glass. The glass may also be soda-lime glass. The glass may contain alkali metal oxides, for example Na₂O, in particular in an amount sufficient to allow chemical tempering.

The glass may comprise the following components, in weight percent: SiO₂ 45.0 to 75.0 wt.-%, B₂O₃ 0 to 10.0 wt.-%, Al₂O₃ 2.5 to 25.0 wt.-%, Li₂O 0 to 10.0 wt.-%, Na₂O 5.0 to 20.0 wt.-%, K₂O 0 to 10.0 wt.-%, MgO 0 to 15.0 wt.-%, CaO 0 to 10.0 wt.-%, BaO 0 to 5.0 wt.-%, ZnO 0 to 5.0 wt.-%, TiO₂ 0 to 5.0 wt.-%, ZrO₂ 0 to 5.0 wt.-%, P₂O₅ 0 to 20.0 wt.-%. In preferred embodiments, the glass consists of the components mentioned in the before-mentioned list to an extent of at least 95.0 wt.-%, more preferably at least 97.0 wt.-%, most preferably at least 99.0 wt.-%.

The terms “X-free” and “free of component X”, respectively, as used herein, preferably refer to a glass, which essentially does not comprise said component X, i.e. such component may be present in the glass at most as an impurity or contamination, however, it is not added to the glass composition as an individual component. This means that the component X is not added in essential amounts. Non-essential amounts according to the present invention are amounts of less than 100 ppm (m/m), preferably less than 50 ppm and more preferably less than 10 ppm. Thereby “X” may refer to any component, such as lead cations or arsenic cations. Preferably, the glasses described herein do essentially not contain any components that are not mentioned in this disclosure.

In an embodiment, the glass may comprise the following components, in weight percent: SiO₂ 45.0 to 72.0 wt.-%, B₂O₃ 0 to 4.7 wt.-%, Al₂O₃ 4.0 to 24.0 wt.-%, Li₂O 0 to 6.0 wt.-%, Na₂O 8.0 to 18.0 wt.-%, K₂O 0 to 8.0 wt.-%, MgO 0 to 10.0 wt.-%, CaO 0 to 3.0 wt.-%, BaO 0 to 2.0 wt.-%, ZnO 0 to 3.0 wt.-%, TiO₂ 0 to 1.0 wt.-%, ZrO₂ 0 to 4.6 wt.-%, P₂O₅ 0 to 15.0 wt.-%.

In an embodiment, the glass may comprise the following components, in weight percent: SiO₂ 51.0 to 65.0 wt.-%, B₂O₃ 0 to 4.7 wt.-%, Al₂O₃ 11.0 to 24.0 wt.-%, Li₂O 0 to 6.0 wt.-%, Na₂O 8.0 to 18.0 wt.-%, K₂O 0 to 8.0 wt.-%, MgO 0 to 5.5 wt.-%, CaO 0 to 1.0 wt.-%, BaO 0 to 1.0 wt.-%, ZnO 0 to 3.0 wt.-%, TiO₂ 0 to 1.0 wt.-%, ZrO₂ 0 to 4.6 wt.-%, P₂O₅ 0 to 10.0 wt.-%.

In an embodiment, the glass may comprise the following components, in weight percent: SiO₂ 45.0 to 72.0 wt.-%, B₂O₃ 0 to 4.7 wt.-%, Al₂O₃ 4.0 to 24.0 wt.-%, Li₂O 0 to 3.0 wt.-%, Na₂O 8.0 to 18.0 wt.-%, K₂O 0 to 8.0 wt.-%, MgO 0 to 5.5 wt.-%, CaO 0 to 1.0 wt.-%, BaO 0 to 2.0 wt.-%, ZnO 0 to 3.0 wt.-%, TiO₂ 0 to 1.0 wt.-%, ZrO₂ 0 to 3.0 wt.-%, P₂O₅ 0 to 15.0 wt.-%.

Lower limits of the amount of SiO₂ may for example be at least 45 wt.-%, at least 51 wt.-%, or at least 55 wt.-%. Upper limits of the amount of SiO₂ may for example be at most 75 wt.-%, at most 72 wt.-%, or at most 65 wt.-%.

Lower limits of the amount of B₂O₃ may for example be at least 0.1 wt.-%, at least 0.2 wt.-%, or at least 0.5 wt.-%. Upper limits of the amount of B₂O₃ may for example be at most 10 wt.-%, at most 5 wt.-%, at most 2 wt.-%, or at most 1 wt.-%. The glass may for example be free of B₂O₃.

Lower limits of the amount of Al₂O₃ may for example be at least 2.5 wt.-%, at least 4 wt.-%, or at least 11 wt.-%. Upper limits of the amount of Al₂O₃ may for example be at most 25 wt.-%, at most 24 wt.-%, or at most 20 wt.-%.

Lower limits of the amount of Li₂O may for example be at least 0.1 wt.-%, at least 0.2 wt.-%, or at least 0.5 wt.-%. Upper limits of the amount of Li₂O may for example be at most 10 wt.-%, at most 6 wt.-%, or at most 3 wt.-%. The glass may for example be free of Li₂O.

Lower limits of the amount of Na₂O may for example be at least 5 wt.-%, at least 8 wt.-%, or at least 10 wt.-%. Upper limits of the amount of Na₂O may for example be at most 20 wt.-%, at most 18 wt.-%, or at most 16 wt.-%.

Lower limits of the amount of K₂O may for example be at least 0.5 wt.-%, at least 1 wt.-%, or for some variants at least 2 wt.-%. Upper limits of the amount of K₂O may for example be at most 10 wt.-%, at most 8 wt.-%, at most 5 wt.-%, at most 3 wt.-%, or for some variants at most 2 wt.-% or at most 1.5 wt.-%. The glass may for example be free of K₂O.

Lower limits of the amount of MgO may for example be at least 0.5 wt.-%, at least 1 wt.-%, or at least 2 wt.-%. Upper limits of the amount of MgO may for example be at most 15 wt.-%, at most 10 wt.-%, or at most 5.5 wt.-%. The glass may for example be free of MgO.

Lower limits of the amount of CaO may for example be at least 0.1 wt.-%, at least 0.2 wt.-%, or at least 0.5 wt.-%. Upper limits of the amount of CaO may for example be at most 10 wt.-%, at most 3 wt.-%, or at most 1 wt.-%. The glass may for example be free of CaO.

Lower limits of the amount of P₂O₅ may for example be at least 0.1 wt.-%, at least 0.2 wt.-%, or at least 0.5 wt.-%. Upper limits of the amount of P₂O₅ may for example be at most 20 wt.-%, at most 15 wt.-%, or at most 10 wt.-%. The glass may for example be free of P₂O₅.

Lower limits of the amount of BaO may for example be at least 0.1 wt.-%, at least 0.2 wt.-%, or at least 0.5 wt.-%. Upper limits of the amount of BaO may for example be at most 5 wt.-%, at most 2 wt.-%, or at most 1 wt.-%. The glass may for example be free of BaO.

Lower limits of the amount of ZnO may for example be at least 0.1 wt.-%, at least 0.2 wt.-%, or at least 0.5 wt.-%. Upper limits of the amount of ZnO may for example be at most 5 wt.-%, at most 3 wt.-%, or at most 1 wt.-%. The glass may for example be free of ZnO.

Lower limits of the amount of ZrO₂ may for example be at least 0.2 wt.-%, at least 0.5 wt.-%, or at least 1 wt.-%. Upper limits of the amount of ZrO₂ may for example be at most 5 wt.-%, at most 4.6 wt.-%, or at most 3 wt.-%. The glass may for example be free of ZrO₂.

Lower limits of the amount of TiO₂ may for example be at least 0.1 wt.-%, at least 0.2 wt.-%, or at least 0.5 wt.-%. Upper limits of the amount of TiO₂ may for example be at most 5.0 wt.-%, at most 2.5 wt.-%, at most 1.5 wt.-%, or at most 1 wt.-%. The glass may for example be free of TiO₂.

The glass element may for example comprise the following components in the indicated amounts (in wt-%).

| Component | Proportion (wt.-%) |
|---|---|
| SiO₂ | 45-75 |
| Al₂O₃ | 2.5-25 |
| Li₂O | 0-10 |
| Na₂O | 5-20 |
| K₂O | 0-10 |
| MgO | 0-15 |
| CaO | 0-10 |
| P₂O₅ | 0-20 |
| BaO | 0-5 |
| ZnO | 0-5 |
| ZrO₂ | 0-5 |
| B₂O₃ | 0-10 or 0-5 |
| TiO₂ | 0-5 or 0-2.5 |

The Young's modulus E of the glass may for example be in a range of from 60 to 80 GPa, or 70 to 75 GPa.

The glass element of the present invention may be chemically toughened, in particular by subjecting the glass element to an ion exchange treatment.

Compressive stress (CS) (also referred to as “Pressure stress” or “surface stress”) is the stress that results from the displacement effect on the glass network through the glass surface after ion exchange, while no deformation occurs in the glass.

“Penetration depth” or “depth of ion exchanged layer” or “ion exchange depth” (“depth of layer” or “depth of ion exchanged layer”, DoL) is the thickness of the glass surface layer in which ion exchange occurs and compressive stress is generated. The compressive stress CS and the penetration depth DoL can be measured optically (in particular by a waveguide mechanism), using the commercially available stress meter FSM6000 (for example company “Luceo Co., Ltd.”, Japan, Tokyo).

When CS is induced on one side or both sides of single glass sheet, to balance the stress according to the 3rd principle of Newton's law, a tension stress must be induced in the center region of glass, and it is called central tension (CT). CT can be calculated from measured CS and DoL values.

Ion exchange means that the glass is hardened or chemically tempered (also called chemically toughened) by ion exchange processes, a process that is well known to the person skilled in the art in the field of glass making and processing. The toughening process may be done by immersing the glass layer into a salt bath which contains monovalent ions to exchange with alkali ions inside the glass. The monovalent ions in the salt bath have radii larger than alkali ions inside the glass. A compressive stress to the glass is built up after ion-exchange due to larger ions squeezing into the glass network. After ion-exchange, the strength and flexibility of glass are significantly improved. In addition, the CS induced by chemical toughening improves the bending properties of the toughened glass layer and increases scratch resistance of the glass layer. The typical salt used for chemical tempering is, for example, K⁺-containing molten salt or mixtures of salts. Optional salt baths for chemical toughening are Na⁺-containing and/or K⁺-containing molten salt baths or mixtures thereof. Optional salts are NaNO₃, KNO₃, NaCl, KCl, Na₂SO₄, K₂SO₄, Na₂CO₃, K₂CO₃, and K₂Si₂O₅. Additives such as NaOH, KOH and other sodium salts or potassium salts are also used to better control the rate of ion exchange for chemical tempering. Ion exchange may for example be done in KNO₃ at temperatures in a range of from 300° C. to 480° C., in particular from 340° C. to 450° C. or from 390° C. to 450° C., for example for a time span of from 30 seconds to 48 hours, in particular for about 20 minutes. Chemical toughening is not limited to a single step. It can include multi steps in one or more salt baths with alkaline metal ions of various concentrations to reach better toughening performance. Thus, the chemically toughened glass layer can be toughened in one step or in the course of several steps, e.g. two steps. Two-step chemical toughening is in particular applied to Li₂O-containing glasses as lithium may be exchanged for both sodium and potassium ions.

The chemically toughened glass element of the invention may have a surface compressive stress CS1 at the first surface and/or a surface compressive stress CS2 at the second surface.

CS1 and/or CS2 may for example be at least 300 MPa, at least 350 MPa, at least 400 MPa, at least 450 MPa, at least 500 MPa, at least 550 MPa, or at least 600 MPa. CS1 and/or CS2 may for example be at most 1500 MPa, at most 1200 MPa, at most 900 MPa, at most 800 MPa, at most 750 MPa, at most 700 MPa, or at most 650 MPa. CS1 and/or CS2 may for example be in a range of from 300 to 1500 MPa, from 350 to 1200 MPa, from 400 to 900 MPa, from 450 to 800 MPa, from 500 to 750 MPa, from 550 to 700 MPa, or from 600 to 650 MPa.

In some embodiments, CS1 and/or CS2 may be smaller than 600 MPa, for example at most 550 MPa, at most 500 MPa, or at most 475 MPa. CS1 and/or CS2 may for example be in a range of from 300 to 600 MPa, from 350 to 550 MPa, from 400 to 500 MPa, or from 450 to 475 MPa.

The surface compressive stress CS1 at the first surface may be equal or substantially equal to the surface compressive stress CS2 at the second surface. The absolute value of the difference CS1-CS2 may for example be less than 10 MPa, at most 8 MPa, at most 5 MPa, at most 2 MPa, or at most 1 MPa.

However, the surface compressive stress CS1 at the first surface may also be substantially higher or lower than the surface compressive stress CS2 at the second surface. The absolute value of the difference CS1-CS2 may for example be at least 10 MPa, at least 15 MPa, at least 20 MPa, at least 30 MPa, or at least 50 MPa. The absolute value of the difference CS1-CS2 may for example be at most 100 MPa, at most 90 MPa, at most 80 MPa, at most 70 MPa, or at most 60 MPa. The absolute value of the difference CS1-CS2 may for example be in a range of from 10 to 100 MPa, from 15 to 90 MPa, from 20 to 80 MPa, from 30 to 70 MPa, or from 50 to 60 MPa.

CS1 and/or CS2 values are not necessarily constant along the entire first or second surface, respectively. However, it is preferred that abrupt changes of CS1 and/or CS2 are avoided.

The total CS variation (TCSV) of the first and/or second surface of the glass element is determined as the difference of the maximum CS (CSₘₐₓ) and the minimum CS (CSₘᵢₙ) on the respective surface.

The local CS variation (LCSV) of the first and/or second surface is determined as the difference of largest CS (LCS) and smallest CS (SCS) of the glass element along a measuring path of 4 mm on the respective surface. Thus, the LCSV is given for a particular measuring path of 4 mm so that there are different local CS variations LCSVᵢ depending on the positioning of the measuring path on the first and/or second surface of the glass element. The measuring path may be positioned on the glass element in any orientation. The different LCSVᵢ values are determined as LCSVᵢ=LCSᵢ-SCSᵢ with i=1, 2, . . . , n (wherein n is number of potentially possible different measuring paths of 4 mm on the first and/or second surface of the glass element). The maximum local CS variation (LCSVₘₐₓ) of the first and/or second surface of the glass element is the largest of all LCSVᵢ values of the respective surface of the glass element. The minimum local CS variation (LCSVₘᵢₙ) of the first and/or second surface of the glass element is the smallest of all LCSVᵢ values of the respective surface of the glass element.

Notably, the edges of the glass element may have varying geometrical properties, for example due to chamfer structures. Therefore, the edge regions are preferably excluded from determining TCSV and LCSV values. Preferably, TCSV and/or LCSV refer to CS values of the first and/or second surface that are spaced apart from the edges of the glass element by at least 0.5 mm. Thus, for example smaller thicknesses at the edges due to chamfer structures are not taken into account for determination of the minimum CS (CSₘᵢₙ) of the glass element. Rather, CSₘᵢₙ is the minimum CS of the first and/or second surface of the glass element at a distance of at least 0.5 mm from the edges. Likewise, the measuring paths of 4 mm for determining the LCSV do preferably not include any position being closer to the edges than 0.5 mm.

First and second surface of the glass element are also referred to as the two main surfaces of the glass element.

The TCSV of the first and/or second surface of the glass element may for example be in a range from 15 to 700 MPa, from 30 to 500 MPa, from 50 to 300 MPa, from 60 to 200 MPa, or from 80 to 100 MPa. The TCSV of the first and/or second surface of the glass element may for example be at least 15 MPa, at least 30 MPa, at least 50 MPa, at least 60 MPa, or at least 80 MPa. The TCSV of the first and/or second surface of the glass element may for example be at most 700 MPa, at most 500 MPa, at most 300 MPa, at most 200 MPa, or at most 100 MPa.

The maximum local CS variation (LCSVₘₐₓ) of the first and/or second surface of the glass element over a measuring path of 4 mm may for example be in a range of from 0.1 to 50 MPa, from 0.2 to 30 MPa, from 0.5 to 20 MPa, from 0.75 to 15 MPa, from 1.0 to 10 MPa, from 1.5 to 5 MPa, or from 2.0 to 2.5 MPa. The LCSVₘₐₓ of the first and/or second surface of the glass element over a measuring path of 4 mm may for example be at least 0.1 MPa, at least 0.2 MPa, at least 0.5 MPa, at least 0.75 MPa, at least 1.0 MPa, at least 1.5 MPa, or at least 2.0 MPa. The LCSVₘₐₓ of the first and/or second surface of the glass element over a measuring path of 4 mm may for example be at most 50 MPa, at most 30 MPa, at most 20 MPa, at most 15 MPa, at most 10 MPa, at most 5 MPa, or at most 2.5 MPa

The minimum local CS variation (LCSVₘᵢₙ) of the first and/or second surface of the glass element over a measuring path of 4 mm may for example be in a range of from 0.0 to 50 MPa, from 0.1 μm to 20 MPa, from 0.2 to 10 MPa, from 0.5 to 5 MPa, or from 1.0 to 2.0 MPa. The LCSVₘᵢₙ of the first and/or second surface of the glass element over a measuring path of 4 mm may for example be 0.0 MPa. Thus, there may be areas of the first and/or second surface of the glass element in which the CS does not change or does not substantially change over a measuring path of 4 mm. However, the LCSVₘᵢₙ of the first and/or second surface of the glass element over a measuring path of 4 mm may for example also be at least 0.1 MPa, at least 0.2 MPa, at least 0.5 MPa, or at least 1.0 MPa. The LCSVₘᵢₙ of the first and/or second surface of the glass element over a measuring path of 4 mm may for example be at most 50 MPa, at most 20 MPa, at most 10 MPa, at most 5 MPa, or at most 2.0 MPa.

The ratio LCSVₘᵢₙ/LCSVₘₐₓ at the first and/or second surface of the glass element may for example be in a range of from 0:1 to 1:1, from 1:100 to 99:100, from 1:10 to 49:50, from 1:5 to 19:20, 1:2 to 9:10, from 2:3 to 8:9, or from 4:5 to 7:8. The ratio LCSVₘᵢₙ/LCSVₘₐₓ may for example be 0:1 in case the first and/or second surface of the glass element includes areas in which the CS does not change or does not substantially change over a measuring path of 4 mm. However, the ratio LCSVₘᵢₙ/LCSVₘₐₓ may for example also be at least 1:100, at least 1:10, at least 1:5, at least 1:2, at least 2:3, or at least 4:5. The ratio LCSVₘᵢₙ/LCSVₘₐₓ may for example be 1:1 or essentially 1:1. The closer the ratio LCSVₘᵢₙ/LCSVₘₐₓ gets to 1:1, the more homogeneous is the CS variation throughout the first and/or second surface of the glass element. In particular, a glass element having a wedge-shaped thickness profile may have a ratio LCSVₘᵢₙ/LCSVₘₐₓ of 1:1 or essentially 1:1. The ratio LCSVₘᵢₙ/LCSVₘₐₓ may for example be at most 1:1, at most 99:100, at most 49:50, at most 19:20, at most 9:10, at most 8:9, or at most 7:8. In some embodiments, the ratio LCSVₘᵢₙ/LCSVₘₐₓ is particularly low, for example at most 1:5, at most 1:10, or at most 1:100. In other embodiments, the ratio LCSVₘᵢₙ/LCSVₘₐₓ is particularly high, for example at least 9:10, at least 19:20, or at least 99:100.

CS1 and/or CS2 may also be adapted to the thickness of the glass element, in particular such that CS1 and/or CS2 are larger at positions at which the thickness of the glass element is larger. Likewise, CS1 and/or CS2 may be lower at positions at which the thickness of the glass element is lower. The surface compressive stress at a position i of a glass element, in particular a glass element having thickness-dependent CS values, may be described based on the following formula as normalized CSᵢ.

$$Normalized {CS}_{i} = \frac{{CS}_{i}}{{log}_{10} \frac{100 \cdot {t}_{i}}{μm}}$$

In this formula, CSᵢ represents the surface compressive stress (CS1 and/or CS2) at a position i of the glass element. The term tᵢ indicates the thickness of the glass element at position i. The term log 10 indicates the decadic logarithm (also known as common logarithm or decimal logarithm). The CSᵢ is given in MPa and thickness tᵢ is given in μm. It is preferred that the normalized CSᵢ is constant throughout the glass element. If the ratio of the normalized CSᵢ at tᵢ=tₘᵢₙ and the normalized CSᵢ at tᵢ=tₘₐₓ is in a range of from 0.95:1 to 1.05:1, the normalized CS of the glass element may be defined as the average of the normalized CSᵢ values at the position of the minimum thickness tₘᵢₙ and at the position of the maximum thickness tₘₐₓ of the glass element. For example, if the normalized CSᵢ at tᵢ=tₘᵢₙ is equal to 200 MPa and the normalized CSᵢ at tᵢ=tₘₐₓ is equal to 202 MPa, the normalized CS of the glass element is defined as 200 MPa+202 MPa divided by 2, which is equal to 201 MPa.

It is preferred that the ratio of the normalized CSᵢ at tᵢ=tₘᵢₙ and the normalized CSᵢ at tᵢ=tₘₐₓ is in a range of from 0.55:1 to 1.45:1, from 0.70:1 to 1.30:1, from 0.85:1 to 1.15:1, or from 0.95:1 to 1.05:1.

The glass element may for example have a normalized CS of at least 100 MPa, at least 125 MPa, at least 150 MPa, at least 175 MPa, or at least 190 MPa. The glass element may for example have a normalized CS of at most 300 MPa, at most 275 MPa, at most 250 MPa, at most 225 MPa, or at most 205 MPa. The glass element may for example have a normalized CS in a range of from 100 to 300 MPa, from 125 to 275 MPa, from 150 to 250 MPa, from 175 to 225 MPa, or from 190 to 205 MPa.

The chemically toughened glass element of the invention may have a first compressive stress layer extending from the first surface of the glass element to a first depth of layer DoL1 and/or a second compressive stress layer extending from the second surface to a second depth of layer DoL2.

DoL1 and/or DoL2 may for example be at least 2.5 μm, at least 5.0 μm, at least 7.5 μm, or at least 10.0 μm. DoL1 and/or DoL2 may for example be at most 40.0 μm, at most 35 μm, at most 30 μm, or at most 25 μm. DoL1 and/or DoL2 may for example be in a range of from 2.5 to 40 μm, from 5.0 to 35 μm, from 7.5 to 30 μm, or from 10.0 to 25 μm.

DoL1 and/or DoL2 may be adapted to the thickness of the glass element. For example, DoL1 and/or DoL2 may be at least 5.0%, at least 7.5%, at least 10.0%, at least 12.5%, at least 15.0%, or at least 17.5% of the thickness of the glass element. DoL1 and/or DoL2 may for example be at most 40.0%, at most 35.0% at most 30.0%, at most 27.5%, at most 25.0%, or at most 22.5% of the thickness of the glass element. DoL1 and/or DoL2 may for example be in a range of from 5.0% to 40.0%, from 7.5% to 35.0%, from 10.0% to 30.0%, from 12.5% to 27.5%, from 15.0% to 25.0%, or from 17.5% to 22.5% of the thickness of the element.

DoL1 and DoL2 may be equal or substantially equal. However, DoL2 may also be higher or lower than DoL1. For example, the ratio DoL2/DoL1 or the ratio DoL1/DoL2 may be higher than 1.00, for example at least 1.01, at least 1.02, at least 1.03, or at least 1.04. The ratio DoL2/DoL1 or the ratio DoL1/DoL2 may for example be at most 1.20, at most 1.15, at most 1.10, at most 1.07, or at most 1.05. The ratio DoL2/DoL1 or the ratio DoL1/DoL2 may for example be in a range of from >1.00 to 1.20, from 1.01 to 1.15, from 1.02 to 1.10, from 1.03 to 1.07, or from 1.04 to 1.05.

Differences of DoL1 and DoL2 may be associated with the glass element having a certain warp. In particular, the glass element may have a warp such that the first surface of the glass element is convex and the second surface of the glass element is concave or vice versa. Without wishing to be bound by a certain theory, this may at least partially be explained by differences of DoL1 and DoL2. As a result, one of the main surfaces may be “pushed” towards the center of the glass element (resulting in a concave surface), whereas the other main surface is in turn “pushed” outwards (resulting in a convex surface). Generally, it is a fixed believe in the field that warp should be avoided. However, in the present case it turned out that a certain warp may even be advantageous for the bendability of the element in some embodiments of the invention. Notably, a main surface of the glass element of the invention facing the user of a bendable electronic device such as a smartphone may represent the inner surface of the bend (in-folded display). As also described above, it is generally the outer surface of a bend that faces particular problems due to the tensile forces. However, a problem occurring towards the inner surface of a bend are so-called folding creases. Interestingly, a convex main surface of the glass element of the invention counteracts the problem of folding creases. Thus, this makes a convex main surface even more suitable for being the inner surface of the bend.

Preferably, the glass element has at least one, more preferably exactly one edge connecting first and second surface thereof. Depending on the shape of the glass element, the edge may have different sides. For example, in case of a sheet or sheet-like glass element having rectangular or squared shape, the edge has four sides, wherein two opposite sides represent the length of the glass element and the remaining two opposite sides represent the width of the glass element. The positions connecting two adjacent sides of the edge are generally referred to as corners.

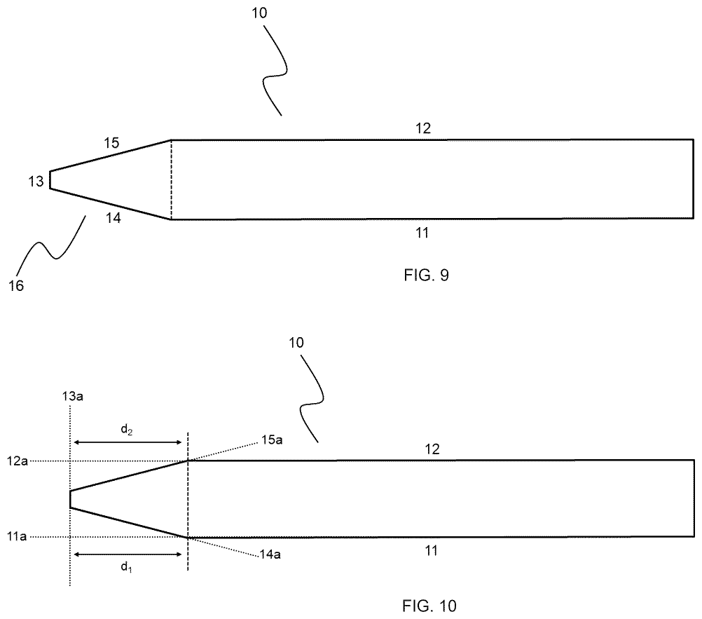

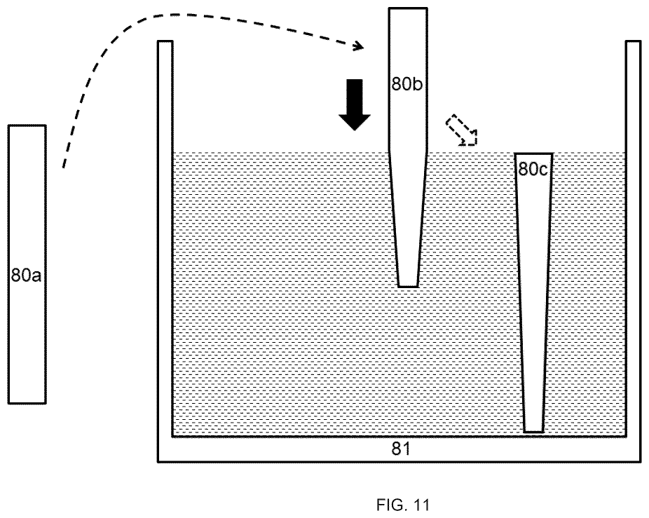

The edge of the glass element of the invention may include a chamfer structure. The glass element of the invention may have a symmetric chamfer structure or an asymmetric chamfer structure. A symmetric chamfer structure is more preferred. A schematic illustration of a cross-sectional profile of a glass element having a symmetric chamfer structure is shown in FIGS. 9 and 10. The chamfer structure may be observed and described best based on an image of a cross-section of a profile of a chamfer structure. In order to obtain such images, the glass element is observed with an optical microscope in transmitted light mode. A 200× magnification is used. The focus is on the top plane so that the edges look very sharp. The glass element is positioned such that the top plane is not tilted. Thus, the top plane is perpendicular to the direction of light. Images of particularly good quality are generally obtained with automatic white balance, automatic brightness and automatic contrast, in particular using Nikon Y-TV55 microscope.

The symmetry/asymmetry of the chamfer structure can easily be described by fitting tangent lines to the relevant surfaces in the microscope image (tangent line 14a to the primary connecting surface, tangent line 11a to the first surface, tangent line 13a to the third surface, tangent line 15a to the secondary connecting surface, and tangent line 12a to the second surface as shown in FIG. 10).

Fitting the tangent lines to respective surfaces may be done by hand using any suitable image processing software, for example ImageJ, PowerPoint, Photoshop, or the like. It will be appreciated that the skilled person is well aware of further suitable software programs. Fitting the lines is easily done by hand. A sufficiently accurate fit is obtained without major effort. However, if desired, fitting may be utilizing for example the method of least squares in order to obtain the best fit, in particular by further software support.

Notably, the transition of one surface into the other may not always be appointed to one specific point. In particular, the secondary connecting surface and/or the primary connecting surface may deviate from a straight line towards the transition into the second surface or into the first surface, respectively. However, this deviation relates to a minor fraction of the primary and secondary connecting surfaces only. Thus, in order to obtain a tangent line to the primary connecting surface, wherein the tangent line deviates from the primary connecting surface as little as possible, the tangent line is fitted such that the best fit is obtained towards the transition of the primary connecting surface to the third surface whereas larger deviations may be acceptable towards the transition of the primary connecting surface to the first surface. The same holds true analogously for fitting the tangent line to the secondary connecting surface.

As shown in FIG. 10, the tangent line 14a to the primary connecting surface crosses the tangent line 11a to the first surface at a distance d₁ from the tangent line 13a to the third surface. Likewise, the tangent line 15a to the secondary connecting surface crosses the tangent line 12a to the second surface at a distance d₂ from the tangent line 13a to the third surface. Both d₁ and d₂ are measured perpendicular to the tangent line 13a to the third surface. The length of distances d₁ and d₂ may in particular be measured using any suitable image processing software, for example ImageJ, PowerPoint, Photoshop, or the like. The measurement may include comparing the lengths of distances d₁ and d₂, respectively, with the length of the scale bar.

In a symmetric chamfer structure, the difference of d₁-d₂ is relatively small or even equal to zero.

The absolute value of the difference d₁-d₂ may for example be less than 30%, at most 25%, at most 20%, at most 15%, at most 10%, at most 5%, or at least 2% of the thickness of the glass element. The absolute value of the difference d₁-d₂ may for example be at least 0.01%, at least 0.02%, at least 0.05%, at least 0.1%, at least 0.2%, at least 0.5%, or at least 1% of the thickness of the glass element. The absolute value of the difference d₁-d₂ may for example be in a range of from 0.01% to <30%, from 0.02% to 25%, from 0.05% to 20%, from 0.1% to 15%, from 0.2% to 10%, from 0.5% to 5%, or from 1% to 2% of the thickness of the glass element.

The absolute value of the difference d₁-d₂ may for example be less than 50 μm, at most 40 μm, at most 30 μm, at most 20 μm, at most 10 μm, or at most 5 μm. The absolute value of the difference d₁-d₂ may for example be at least 0.01 μm, at least 0.02 μm, at least 0.05 μm, at least 0.1 μm, at least 0.2 μm, or at least 0.5 μm. The absolute value of the difference d₁-d₂ may for example be in a range of from 0.01 to <50 μm, from 0.02 to 40 μm, from 0.05 to 30 μm, from 0.1 to 20 μm, from 0.2 to 10 μm, or from 0.5 to 5 μm.

The distance d₁ and/or the distance d₂ may for example be at least 30 μm, at least 35 μm, at least 40 μm, at least 45 μm, at least 50 μm, at least 60 μm, at least 70 μm, at least 80 μm, or at least 90 μm. The distance d₁ and/or the distance d₂ may for example be at most 1000 μm, at most 750 μm, at most 500 μm, at most 250 μm, at most 100 μm, at most 90 μm, at most 80 μm, at most 70 μm, or at most 60 μm. The distance d₁ and/or the distance d₂ may for example be in a range of from 30 to 1000 μm, from 50 to 1000 μm, from 60 to 750 μm, from 70 to 500 μm, from 80 to 250 μm, or from 90 to 100 μm, or in a range of from 30 to 100 μm, from 35 to 90 μm, from 40 to 80 μm, from 45 to 70 μm, or from 50 to 60 μm.

The present invention also relates to a stack assembly comprising a glass element, in particular a glass element of the invention,
wherein the stack assembly is characterized by an absence of failure when the stack assembly is held for 60 minutes at a bending radius R of 5.0 mm at the center of a flexible region of the glass element, in particular at a temperature of 25° C. and a relative humidity of 40%, and,
wherein the stack assembly comprises an index-matched filler in a maximum thickness of less than 20 μm, or less than 15 μm, or less than 10 μm, or less than 5 μm, wherein the index-matched filler has a refractive index n_{d} that deviates from the refractive index n_{d} of the glass element by at most 0.01.

It is a particular advantage of the present invention that optical distortions are avoided or at least strongly reduced by the smooth thickness transition (low LTVₘₐₓ) of the invention. This enables strong reduction of the amount of index-matched fillers used in the prior art for reduction of optical distortions due to thickness variations of the glass element. In some embodiments, the stack assembly is even free of index-matched fillers.

The amount of optical distortion may be quantified based on a group of suitable people forming a test panel in a test of optical distortion. The inspection of the stack assemblies is done by naked eyes, and if there is a visible shadow or a line or any other visible defect, the member of the test panel judges the stack assembly as having an optical distortion. Suitable members of the test panel must not exhibit any visual impairment and must be in good health. In particular, no eye infections should impair their sense of vision. At least six members of the test panel, preferably at least 10, more preferably at least 15 or even more preferably at least 20 members of the test panel are presented with stack assemblies. The respective members are presented with the stack assemblies independent of each other and rate the stack assembly in a yes or no fashion as either having optical distortion or not having optical distortion. A stack assembly is characterized as not having optical distortion if at least 80%, more preferably at least 90%, more preferably at least 95%, more preferably 100% of the members of the panel that were presented with the stack assembly qualify it as not having optical distortion.

The present invention also relates to a stack assembly comprising a glass element, in particular a glass element of the invention,
wherein the stack assembly is characterized by not having optical distortion, and,
wherein the stack assembly comprises an index-matched filler in a maximum thickness of less than 20 μm, or less than 15 μm, or less than 10 μm, or less than 5 μm, wherein the index-matched filler has a refractive index n_{d} that deviates from the refractive index n_{d} of the glass element by at most 0.01.

The present invention also relates to a stack assembly comprising a glass element, in particular a glass element of the invention,
wherein the stack assembly is characterized by not having optical distortion and/or by an absence of failure when the stack assembly is held for 60 minutes at a bending radius R of 5.0 mm at the center of a flexible region of the glass element, in particular at a temperature of 25° C. and a relative humidity of 40%, and,
wherein the stack assembly comprises an index-matched filler in a maximum thickness of less than 20 μm, or less than 15 μm, or less than 10 μm, or less than 5 μm, wherein the index-matched filler has a refractive index n_{d} that deviates from the refractive index n_{d} of the glass element by at most 0.01.

The present invention also relates to a stack assembly comprising a glass element, in particular a glass element of the invention,
wherein the stack assembly is characterized by an absence of failure when the stack assembly is repeatedly bent 100,000 times to a bending radius R at the center of a flexible region of the glass element, in particular at a temperature of 25° C. and a relative humidity of 40%, wherein for each bending axis with a bending radius of R, within a width of 4.378*R (along the direction perpendicular to the bending axis; not parallel), the glass element has an average thickness t_{avg} as shown in the following formula, wherein E is the Young's modulus of the glass:

$${t}_{avg} \leq \frac{2500 MPa * R}{1.198 * E}$$

and wherein the stack assembly comprises an index-matched filler in a maximum thickness of less than 20 μm, or less than 15 μm, or less than 10 μm, or less than 5 μm, wherein the index-matched filler has a refractive index n_{d} that deviates from the refractive index n_{d} of the glass element by at most 0.01.

The refractive index n_{d} of the index-matched filler may for example deviate from the refractive index n_{d} of the glass element by at most 0.005, or by at most 0.004. The refractive index n_{d} of the index-matched filler may for example deviate from the refractive index n_{d} of the glass element by at least 0.0001, by at least 0.0002, or by at least 0.0005. The absolute value of the difference of the refractive index n_{d} of the index-matched filler and of the refractive index n_{d} of the glass element may for example be in a range of from 0.0001 to 0.01, or from 0.0002 to 0.005, or from 0.0005 to 0.004.

The index-matched filler may for example comprise a polymer. The index-matched filler may for example be an optically clear resin (OCR).

Further advantages come from the manufacturing methods, which include direct hot-forming, cold processing and different etching techniques. These methods can be applied as stand-alone solutions or be combined in a processing workflow.

The present invention also relates to a method of producing a glass element of the invention.

In particular, the invention relates to a method for producing a glass element, in particular the glass element of the present invention, the method comprising one or more of the following steps:
Hot-forming via slit down draw, in particular including nozzle contours specifically adjusted to the thickness profile of the glass element,
Hot-forming via overflow down draw, in particular including a tilted overflow trough or an overflow trough with an height level profile specifically adjusted to the thickness profile of the glass element,
Hot-forming via redraw of a starting glass article adjusted to the thickness profile of the glass element,
Hot-pressing or heating a starting glass article on a tilted surface,
Etching a starting glass article,
Mechanically grinding and/or polishing a starting glass article to the desired thickness profile.

The most cost effective production method, delivering the most pristine surface qualities is hot-forming via a down draw technique. The method of the invention may in particular comprise hot-forming via slit down draw or via overflow down draw. Such down draw techniques may in particular include production of a glass ribbon from molten glass flowing out of a drawing tank. The glass ribbon may then be drawn by suitable rollers. In particular in the slit down draw method, the molten glass may flow out of the drawing tank through a nozzle. Preferably, the glass ribbon passes through a forming zone beneath the nozzle and/or through an annealing oven that is preferably beneath the forming zone.

By using the slit down draw method with appropriate distinct nozzle contours and optionally adjusting the temperature profile of the drawing tank and below the drawing tank accordingly, glass ribbons with appropriate thickness profiles can be produced. In the easiest case, a wedge-shaped ribbon could be produced with a suitable nozzle contour and optionally a beneficial drawing and/or cooling profile. Similar wedge shaped glass ribbons can be produced using the overflow down draw method with a tilted overflow trough (forming body). However in general, asymmetric ribbons are difficult to produce and may lead to problems due to tensions in the glass. Therefore, a more preferable approach would be to produce glass ribbons having either belly- or dumbbell-shaped thickness profiles using either down draw method (FIGS. 3A and 3B). With regard to controlling tensions in the glass and its warp, it is however easier to produce a glass element with a thicker center section (belly-shaped) than a glass element with thinner center section (dumbbell-shaped).

The glass element may in particular have a symmetric thickness profile, for example a belly-shaped or a dumbbell-shaped thickness profile. Glass elements having a symmetric thickness profile, in particular a belly-shaped or a dumbbell-shaped thickness profile, may preferably be produced by using the slit down draw method with appropriate distinct nozzle contours and optionally adjusting the temperature profile of the drawing tank and of the forming zone beneath the nozzle and/or of the annealing oven accordingly.

For a belly-shaped thickness profile the nozzle contours are preferably such that the nozzle opening is larger in the center than on the sides. The temperature profile of the drawing tank may preferably be adjusted such that the temperature is higher in the center and lower on the sides. The temperature profile of the forming zone and/or of the annealing oven may preferably be adjusted such that the cooling is higher in the center than on the sides of the glass ribbon.

For a dumbbell-shaped thickness profile the nozzle contours are preferably such that the nozzle opening is narrower in the center than on the sides. The temperature profile of the drawing tank may preferably be adjusted such that the temperature is lower in the center and higher on the sides. The temperature profile of the forming zone and/or of the annealing oven may preferably be adjusted such that the cooling is lower in the center than on the sides of the glass ribbon.

A ribbon having a belly-shaped or a dumbbell-shaped thickness profile can easily be split in half to provide a glass element having a wedge-shaped thickness profile. The method may in particular comprise the step of cutting the glass element with symmetric thickness profile in order to obtain at least two glass elements with asymmetric thickness profile, in particular a wedge-shaped thickness profile. In addition, both aforementioned thickness profiles can, in the suitable width, directly be used for the two above mentioned embodiments of the glass element, e.g. the single-fold or the “Gate-fold” type display. In addition to the nozzle contour and temperature profile of the drawing tank, it can be beneficial to adjust the cooling and/or heating within the forming zone beneath the nozzle and/or in the annealing oven. To adjust the thickness profile of the glass ribbon, cooling and/or heating and controlling the amount of cooling or heating, in different areas of the forming zone can be used to adjust the preferred thickness profile. As such, heating of areas of the glass ribbon will lead to thinning of the ribbon in the respective areas, while cooling will preserve the thickness in certain spots. For cooling, water or air coolers (direct or indirect and also aerosol of water and air) can be used, whereas for heating, reflective materials, air heaters, heating coils or even laser beams can be used. With the latter, the thickness profile can be adjusted very precisely. Such a glass ribbon with an adjusted thickness profile will need an adjusted temperature profile for cooling in the annealing zone to control glass ribbon tensions. The method of the invention may in particular comprise cooling and/or heating in an annealing oven. The cooling may in particular comprise water coolers and/or air coolers and/or aerosol coolers. The coolers may be direct or indirect. The heating may in particular comprise air heaters, heating coils and/or laser beams.

Other hot-forming methods can include for instance using redrawing a glass ribbon from a wedge-shaped pre-cast glass block made by die-casting or CNC (Computerized Numerical Control) machining, etc., hot-pressing or heating glass on a tilted surface to create wedge like cross sections by the flow of glass under gravity. The method of the invention may in particular comprise hot-forming via redraw of a starting glass article having a wedge-shaped thickness profile. The wedge-shaped thickness profile of the starting glass article may in particular be obtained by die-casting and/or CNC machining.

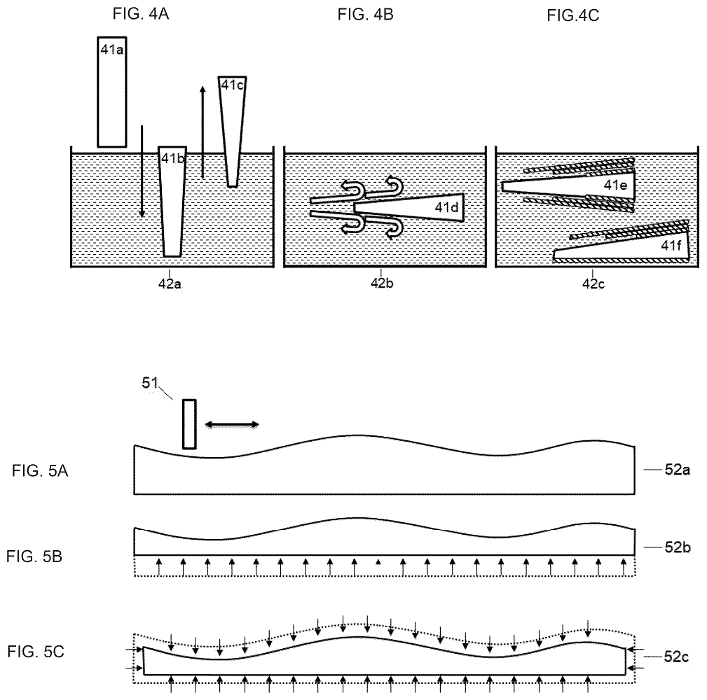

In addition to the hot-forming method, differential etching of thicker glass can be applied. Here, multiple methods can be considered. One potential method is dip-etching, wherein the glass is dipped into a tank filled with etching solution and then slowly lifted from the solution, thereby the glass surface is etched for different lengths of time, when the dipping and lifting is performed with constant velocities this leads to a continuous wedge-shaped thickness profile (FIG. 4A). Another etching technique is to flow or spray etching solution from one end face of the glass along the main surfaces, leading to increased removal of material on the side from which the (spray or flow of) etchant impacts the glass (FIG. 4B). Importantly, here “side” is not “surface” but rather means the end face of the glass element as illustrated in FIG. 4B. Furthermore, covering and thereby protecting parts of the surfaces with etch-resistant coatings (e.g. foil, coatings etc.) can help creating more complex thickness profiles-herein different amounts of the surface areas can sequentially be covered and by multiple etching steps continuous thickness profiles can be achieved (FIG. 4C).

In another etching method, the glass is gradually immersed into a tank filled with etching solution, in particular with a constant speed. Thereby the glass surface is etched for different lengths of time. When the immersion is performed with constant velocities this leads to a continuous wedge-shaped thickness profile (FIG. 11). The terms “immersion speed” and “immersion velocity” are used interchangeably herein and preferably refer to the average immersion speed if not indicated otherwise. The immersion speed is preferably in a range of from 1 mm/min to 50 mm/min, for example from 2 mm/min to 25 mm/min, from 4 mm/min to 15 mm/min, or from 6 mm/min to 10 mm/min. The immersion speed may preferably be at least 1 mm/min, more preferably at least 2 mm/min, more preferably at least 4 mm/min, more preferably at least 6 mm/min. The immersion speed may preferably be at most 50 mm/min, more preferably at most 25 mm/min, more preferably at most 15 mm/min, more preferably at most 10 mm/min.

The immersion speed is preferably constant. This is advantageous for achieving very constant LTVₘₐₓ. Preferably, the ratio of maximum immersion speed and minimum immersion speed is at most 1.25:1, more preferably at most 1.10:1, more preferably at most 1.05:1, more preferably at most 1.02:1, more preferably at most 1.01:1.

The immersion speed may also be adapted to the etching speed or to the speed of reduction of thickness, respectively. The etching speed is generally given in the unit “μm per minute per side”. The term “per side” refers to the fact that the glass element has two sides, namely a first surface and a second surface. Thus, in order to describe the speed of reduction of thickness by the etching process, the etching speed “per side” has to be multiplied by 2 because there are two sides. For example, if the etching speed is 1 μm per minute per side, the speed of reduction of thickness of the glass element is 2 μm per minute. The speed of reduction of thickness indicates the speed of reduction of thickness of the glass article or glass element upon exposure to the etching solution. For example, if the speed of reduction of thickness is 2 μm per minute, the thickness of the glass article or glass element is reduced by 2 μm per minute upon exposure to the etching solution.

Preferably, the ratio of the immersion speed (in mm per minute) and the speed of reduction of thickness (in μm per minute) is in a range of from 500:1 to 50,000:1, for example from 1,000:1 to 25,000:1, or from 2,000:1 to 10,000:1. The ratio of the immersion speed and the speed of reduction of thickness may preferably be at least 500:1, more preferably at least 1,000:1, and more preferably at least 2,000:1. The ratio of the immersion speed and the speed of reduction of thickness may preferably be at most 50,000:1, more preferably at most 25,000:1, and more preferably at most 10,000:1.

Preferred etching solutions comprise HF and/or HNO₃. The etching speed is preferably in a range of from 0.1 to 10.0 μm per minute per side, for example from 0.2 to 5.0 μm per minute per side, or from 0.5 to 2.0 μm per minute per side. The etching speed is preferably at least 0.1 μm per minute per side, more preferably at least 0.2 μm per minute per side, more preferably at least 0.5 μm per minute per side. The etching speed is preferably at most 10.0 μm per minute per side, more preferably at most 5.0 μm per minute per side, more preferably at most 2.0 μm per minute per side.

The speed of reduction of thickness is preferably in a range of from 0.2 to 20.0 μm per minute, for example from 0.5 to 10.0 μm per minute, or from 1.0 to 5.0 μm per minute. The speed of reduction of thickness is preferably at least 0.2 μm per minute, more preferably at least 0.5 μm per minute, more preferably at least 1.0 μm per minute. The speed of reduction of thickness is preferably at most 20.0 μm per minute, more preferably at most 10.0 μm per minute, and more preferably at most 5.0 μm per minute.

The mentioned glass elements can also be produced by mechanical grinding or polishing (FIG. 5A). However, in the thickness ranges needed for such foldable glass elements, angled grinding or polishing can be extremely challenging. A solution can be a combination of mechanical and chemical treatment techniques. As such, a desired thickness profile can be introduced into a thicker sheet of glass by mechanical abrasion and the glass can afterwards be slimmed down to the target thickness by chemical etching (FIGS. 5B and 5C). The etching process can thereby either be done homogeneously on the whole glass body (full body etching, for example as shown in FIG. 5C) or it can be applied only to one or more surface(s) by protecting the other surfaces with a respective etch-resistant coating (for example as shown in FIG. 5B).

The method of the invention may in particular comprise etching a starting glass article, wherein the etching comprises one or more of the following:
Dip-etching, wherein the starting glass article is repeatedly dipped into an etching solution and removed from the etching solution,
Flowing or spraying etching solution from one end of the starting glass article along the first surface and/or second surface of the glass article,
Covering parts of the first surface and/or second surface of the starting glass article and subsequently contacting the starting glass article with an etching solution, wherein the covering prevents or reduces etching removal from the covered surface parts.

The covering may in particular comprise a foil and/or a coating.

The method of the invention may in particular comprise mechanical grinding and/or polishing, in particular prior to an etching step.

In addition to the aforementioned examples, further developments of manufacturing methods can include combinations of the aforementioned hot-forming, cold processing and etching techniques. As such, in some embodiments of displays, it can be beneficial to protect one or multiple surfaces of the glass from etching solutions, whereby pristine fire-polished surfaces can be preserved. Such glass elements, can provide excellent surface qualities and increased bending strengths.

Additional benefits of wedge-shaped glass elements that are produced via hot-forming can be, that in common stack processing methods, such wedges can be laminated in alternating opposite directions, whereby glue layers of uniform/constant thicknesses can be used and stacks of such glasses will not be tilted in one or the other direction, thus simplifying handling and processing.

Furthermore, aforementioned glass elements can be subjected to common chemical toughening methods, in particular in order to further improve impact resistance and/or bending properties. Thus, the method may in particular comprise a step of chemically toughening the glass element, in particular by ion exchange.

The present invention also relates to a bendable device comprising a glass element and/or the stack assembly of the invention. The bendable device may for example be bendable to a bending radius of from 1 to 5 mm, in particular for 60 minutes without failure at a temperature of 25° C. and a relative humidity of 40%. The bendable device may for example be an electronic device, in particular a smartphone.

The present invention also relates to the use of a glass element and/or a stack assembly of the invention in foldable consumer electronics, such as mobile phones, tablets, computers, in particular laptops, and/or in screens of monitors or televisions.

FIGS. 1A, 1B and 1C schematically show cross-sections of glass elements according to different embodiments of the invention having different thickness profiles of the invention. FIG. 1A shows a glass element having a wedge-shaped thickness profile. FIG. 1B shows a glass element having a thickness profile with a thicker mid-section and two thinner outer sections. FIG. 1C shows a glass element having a thickness profile with an undulating contour on one surface.

FIGS. 1D, 1E and 1F schematically show the glass elements of FIGS. 1A, 1B and 1C, respectively, in potential folded states. The thickness profile is omitted in the schemes of FIGS. 1D, 1E and 1F for ease of presentation. The embodiment of FIGS. 1A and 1D may for example adopt an S-fold or a G-fold. The embodiment of FIGS. 1B and 1E may for example adopt a so-called “gate fold”. The embodiment of FIGS. 1C and 1F allows multiple folds.

FIG. 2 schematically shows another embodiment in which the glass element can be rolled up on one side of it, while the other side can stay either straight or be additionally folded.

FIGS. 3A and 3B schematically show a method of producing a glass element of the invention by hot-forming via slit down draw with a slit down draw apparatus 31 producing a glass ribbon 32 whose dimensions are schematically indicated by dotted lines. In FIGS. 3A and 3B, the slit down draw apparatus differs with respect to the shape of the nozzle which is dumbbell-shaped in FIG. 3A and belly-shaped in FIG. 3B. The differently shaped nozzle of the slit down apparatus 31 results in differently shaped glass elements 33a. Glass element 33a has a dumbbell-shaped thickness profile in FIG. 3A and a belly-shaped thickness profile in FIG. 3B, respectively. Glass element 33a can be cut (schematically indicated by scissors in FIGS. 3A and 3B) in order to obtain glass elements 33b having an asymmetric thickness profile, for example a wedge-shaped thickness profile.

FIGS. 4A, 4B, and 4C schematically show etching techniques that can be applied for obtaining glass elements of the present invention.

FIG. 4A shows a glass article 41a that is repeatedly dipped into and removed from an etching solution contained in a container 42a as indicated by the arrows. Repeated dipping and removing results in a glass element 41b having a wedge-shaped thickness profile. Further dipping and removing can be used for obtaining a glass element 41c having a more pronounced wedge-shaped thickness profile.

FIG. 4B schematically shows a flow of etching solution (indicated by arrows) in container 42b from one end face of the glass element 41d along the first surface and along the second surface of glass element 41d. The flow of the etching solution leads to increased removal of material from the one end face of the glass element 41d, thus resulting in a wedge-shaped thickness profile.

FIG. 4C schematically shows glass elements 41e and 41f located in an etching solution in container 42c. The surfaces of the glass elements are protected from the etching solution to different degrees by different coverings (such as coatings or foils) indicated by elongated rectangles filled with a striped pattern. Based on the arrangement of the coverings, complex thickness profiles can be generated, for example a wedge-shaped thickness profile of glass element 41e or a ramp-shaped thickness profile of glass element 41f.

FIG. 5A schematically shows producing a glass element 52a having a thickness profile of the invention with a CNC tool 51. FIGS. 5B and 5C show that the thickness profile of the glass element can be further modified by etching as indicated by the arrows. The original thickness profile is indicated by dotted lines. The etching process results in additional material removal leading to glass elements 52b and 52c, respectively, whose thickness profile is indicated by solid lines.

FIGS. 6A and 6B schematically show the cross-section of a glass element of the invention having a wedge-shaped thickness profile.

As shown in FIG. 6A, the glass element may comprise at least a first flexible region characterized by an absence of failure when the first flexible region is held at a first bending radius R₁ around bending axis B₁ for 60 minutes and at least a second flexible region characterized by an absence of failure when the second flexible region is held at a second bending radius R₂ around bending axis B₂ for 60 minutes. The bending axes of the first and second flexible regions are indicated by the dashed lines B₁ and B₂, respectively. The widths of the flexible regions (indicated by distance of dotted lines) are defined as 4.378*R₁ and 4.378*R₂, respectively, along the direction perpendicular to the bending axes B₁ and B₂, respectively, with the bending axes forming the centers of the flexible regions.

As shown in FIG. 6B, the glass element has a minimum thickness tₘᵢₙ and a maximum thickness tₘₐₓ. The glass element has a thickness t₁ at the position of the first bending axis B₁ and a thickness t₂ at the position of the second bending axis B₂. Within the width of the flexible regions of 4.378*R (along the direction perpendicular to the bending axis; not parallel) the glass element should preferably have an average thickness t_{avg} as shown in the following formula, wherein E is the Young's modulus of the glass:

$${t}_{avg} \leq \frac{3000 MPa * R}{1.198 * E}$$

In the glass element as shown in FIG. 6B, the average thickness t_{avg} in the flexible regions corresponds to the thickness t₁ at the bending axis B₁ of the first flexible region and to the thickness t₂ at the bending axis B₂ of the second flexible region in view of the wedge-shaped thickness profile of the glass element. Thus,

$${t}_{1} \leq \frac{3000 MPa * {R}_{1}}{1.198 * E} and {t}_{2} \leq \frac{3000 MPa * {R}_{2}}{1.198 * E} .$$

For example, if the Young's modulus E of a glass is about 70 GPa and a bending radius R₁ of 1.5 mm as well as a bending radius R₂ of 5.0 mm are desired, t₁ should be at most about 54 μm and t₂ should be at most about 179 μm.

The following table summarizes the dimensions of a glass element of the invention that fulfills these requirements based on a wedge-shaped thickness profile as shown in FIG. 6B.

| tₘᵢₙ | t₁ | t₂ | tₘₐₓ | d₁ | d₂ | d₃ | dₜₒₜₐₗ |
|---|---|---|---|---|---|---|---|
| 10 | 34 | 66 | 90 | 60 | 80 | 60 | 200 |
| μm | μm | μm | μm | mm | mm | mm | mm |

Notably, such a glass element would even have a thickness t₂ that is small enough to fulfill the above-described equation at a bending radius R₂ of 3.0 mm.

A glass element having the thickness and distance values as shown in table is particularly preferred due to the homogeneous thickness profile giving rise to a constant LTV along the glass element. For example, the thickness variation from tₘᵢₙ to t₁ is 24 μm over a length of 60 mm. This corresponds to a thickness variation of 0.4 μm per mm, or in other words an LTV of 1.6 μm over a measuring path of 4 mm. Likewise, the thickness variation from t₂ to tₘₐₓ is 24 μm over a length of 60 mm, corresponding to a thickness variation of 0.4 μm per mm, or in other words an LTV of 1.6 μm over a measuring path of 4 mm. The thickness variation from t₁ to t₂ is 33 μm over a length of 80 mm, corresponding to a thickness variation of 0.4 μm per mm, or in other words an LTV of 1.6 μm over a measuring path of 4 mm as well. Thus, the local thickness variation is homogeneous throughout the glass element so that the ratio LTVₘᵢₙ/LTVₘₐₓ is 1:1.

The distance dₜₒₜₐₗ between the position of the minimum thickness tₘᵢₙ and the maximum thickness tₘₐₓ may in particular correspond to the length or width of the glass element except for a safety distance of 0.5 mm from the edges that should be observed in determining tₘᵢₙ and tₘₐₓ in order to exclude irregularities at the edges such as for example chamfer structures.

FIGS. 7A and 7B are schematic representations of the set-up of the ball-on-ring test not drawn to scale. FIG. 7A shows a top/bottom view of the set-up. FIG. 7B shows a cross-sectional view of the set-up. In the ball-on-ring test, surface 75 of a glass element 71 is placed on a steel ring 72 with an inner diameter of 4 mm and an outer diameter of 6 mm. The ring is 3 mm deep, and the wall of the ring is 1 mm thick with the tip of the wall having a semi-circle with a diameter of 1 mm as cross-section. A tungsten carbide ball 73 having a diameter of 1 mm is pressed against the surface 74 of the glass element 71 along the center axis of the ring, with a speed of 5 mm/min until the glass shutters. The force at failure is recorded as the ball-on-ring failure force.

FIG. 8 is a picture obtained by an interferometer (Verifire™ manufactured by Zygo Corporation) of a wedge-shaped glass element of the invention having a width of 71 mm and a length of 156 mm. The evenly distributed contour lines are indicating the smooth thickness change from one end to another. The thickness is constant along each particular line. The minimum thickness tₘᵢₙ was 32 μm and the maximum thickness tₘₐₓ was 69 μm resulting in a total thickness variation (TTV) determined as tₘₐₓ-tₘᵢₙ of 37 μm. The maximum local thickness variation (LTVₘₐₓ) over a measuring path of 4 mm was about 0.95 μm. The ratio LTVₘᵢₙ/LTVₘₐₓ was essentially 1:1.

FIG. 9 schematically shows the profile of a glass element 10 comprising a first surface 11, a second surface 12 and at least one edge connecting the first surface 11 and the second surface 12. In the illustration of FIG. 9, the first surface 11 and the second surface 12 appear essentially parallel to each other. However, this is mainly done for ease of illustration. For example, in a wedge-shaped glass element such cross-sectional profile may be observed in a view facing the side with the largest thickness or in a view facing the side with the smallest thickness. Facing one of the other sides will show that first and second surface of a wedge-shaped glass element are not parallel to each other as for example shown in FIGS. 1A and 1n FIG. 6. In the illustration of FIG. 9, the edge has a chamfer structure 16 comprising three surfaces, namely (i) a third surface 13, (ii) a primary connecting surface 14 connecting the third surface 13 and the first surface 11, and (iii) a secondary connecting surface 15 connecting the third surface 13 and the second surface 12. The chamfer structure 16 of the glass element 10 as shown in FIG. 9 is symmetrical.

FIG. 10 schematically illustrates a preferred way of determining symmetry/asymmetry of a chamfer structure. In the illustration of FIG. 10, the first surface 11 and the second 12 are shown essentially parallel to each other. However, as discussed above with respect to FIG. 9, this mainly done for ease of illustration. The illustration in FIG. 10 may in particular be used for determining symmetry/asymmetry of a chamfer structure based on a cross-sectional microscope image of a glass element. Tangent lines to the relevant surfaces are indicated as dotted lines (tangent line 14a to the primary connecting surface, tangent line 11a to the first surface, tangent line 13a to the third surface, tangent line 15a to the secondary connecting surface, and tangent line 12a to the second surface). Fitting the tangent lines to respective surfaces may for example be done by hand using ImageJ software (for example version 1.53i of Mar. 24, 2021). Notably, the secondary connecting surface and/or the primary connecting surface may deviate from a straight line towards the transition into the second surface or into Confidential the first surface, respectively. Therefore, the tangent line should be fitted such that the best fit is obtained towards transition of the primary connecting surface to the third surface whereas a larger deviation may be acceptable towards the transition of the primary connecting surface to the first surface. The same is true analogously for fitting the tangent line to the secondary connecting surface. As shown in FIG. 10, the tangent line 14a to the primary connecting surface crosses the tangent line 11a to the first surface at a distance d₁ from the tangent line 13a to the third surface. Likewise, the tangent line 15a to the secondary connecting surface crosses the tangent line 12a to the second surface at a distance d₂ from the tangent line 13a to the third surface. Both d₁ and d₂ are measured perpendicular to the tangent line 13a to the third surface, for example using ImageJ software. Measuring may in particular be done by comparing the lengths of distances d₁ and d₂, respectively, with the length of a scale bar.

FIG. 11 schematically shows another etching technique that can be applied for obtaining glass elements of the present invention. A starting glass article 80a is gradually immersed into an etching solution contained in a container 81 with constant speed as indicated by the arrows. Gradual immersion results first in an intermediate glass article 80b and finally in a final glass element 80c having a wedge-shaped thickness profile. The starting glass article 80a does not have a wedge-shaped thickness profile. The intermediate glass article 80b comprises a part having a wedge-shaped thickness profile (the part already immersed in the etching solution) and a part that does not have a wedge-shaped thickness profile (the part not yet immersed in the etching solution). The final glass element 80c has a wedge-shaped thickness profile over its entire length.

### EXAMPLES

A glass element having a wedge-shaped thickness profile was obtained by gradually immersing it into an etching solution as schematically shown in FIG. 11 with a constant speed of about 8 mm per minute. The etching solution contained HF and HNO₃. The etching speed was about 1 μm per minute per side, which corresponds to a reduction of thickness about 2 μm per minute.

Prior to the etching step, the starting glass article had a thickness of 70 μm, a width of 71 mm and a length of 156 mm. By gradually immersing the glass element into the etching solution, the glass surface was etched for different lengths of time. One end of the glass element was in the etching solution already for a time of 156 mm divided by 8 mm per minute, which is equal to 19.5 minutes, at the point of time at which the opposite end of the glass element was immersed into the etching solution. Thus, based on the thickness reduction of about 2 μm per minute, it can be calculated that the thickness at the one end of the glass element should be lower by about 2 μm per minute times 19.5 minutes, which is equal to 39 μm. Hence, the expected TTV is 39 μm. This estimated value is very close to the actual data based on measurements of the thickness of the glass element at different locations with a micrometer. The minimum thickness tₘᵢₙ was found at the one end of the glass element and was 32 μm. The maximum thickness tₘₐₓ was found at the opposite end of the glass element and was 69 μm. Thus, the TTV was 37 μm.

The local thickness variation (LTV) was constant along the length of the glass element as shown in FIG. 8. The ratio LTVₘᵢₙ/LTVₘₐₓ was essentially 1:1. The evenly distributed contour lines in FIG. 8 are indicating the smooth thickness change from one end to another. The thickness is constant along each particular line.

In view of the wedge-shaped thickness profile with constant thickness variation along the length of the glass element, it can be calculated that LTVₘₐₓ=LTVₘᵢₙ=TTV/length=37 μm/156 mm which is equal to about 0.95 μm over a measuring path of 4 mm.

### LIST OF REFERENCE SIGNS

10 Glass element
11 First surface
11a Tangent line to first surface
12 Second surface
12a Tangent line to second surface
13 Third surface
13a Tangent line to third surface
14 Primary connecting surface
14a Tangent line to primary connecting surface
15 Secondary connecting surface
15a Tangent line to secondary connecting surface
16 Chamfer structure
31 Slit down draw apparatus
32 Glass ribbon
33a, 33b Glass element
41a-41f Glass element
42a, 42b Container
51 CNC tool
52a-52c Glass element
71 Glass element
72 Steel ring
73 Tungsten carbide ball
74 Surface
75 Surface
80a Starting glass article
80b Intermediate glass article
80c Wedge-shaped glass element
81 Container

1-67. (canceled)

68. A glass element having a first surface and a second surface, wherein the glass element is characterized by the following thickness profile:
the glass element has a minimum thickness tₘᵢₙ and a maximum thickness tₘₐₓ, wherein tₘᵢₙ is at least 10 μm and tₘₐₓ is at most 400 μm, a total thickness variation (TTV) of the glass element is in a range of from 10 μm to 390 μm, and a maximum local thickness variation (LTVₘₐₓ) of the glass element over a measuring path of 4 mm is at most 69 μm.

69. The glass element of claim 68, wherein the TTV of the glass element is at least 30 μm.

70. The glass element of claim 68, wherein tₘᵢₙ is at most 100 μm.

71. The glass element of claim 68, wherein tₘₐₓ is at least 60 μm.

72. The glass element of claim 68, wherein tₘₐₓ is at most 150 μm.

73. The glass element of claim 68, wherein a ratio tₘₐₓ/tₘᵢₙ is in a range of from 3:2 to 40:1.

74. The glass element of claim 73, wherein the ratio tₘₐₓ/tₘᵢₙ is at most 5:1.

75. The glass element of claim 68, wherein the maximum local thickness variation (LTVₘₐₓ) of the glass element over a measuring path of 4 mm is at most 5 μm.

76. The glass element of claim 68, wherein a ratio LTVₘₐₓ/TTV is in a range of from 0.1% to 50.0%.

77. The glass element of claim 68, wherein a minimum local thickness variation (LTVₘᵢₙ) of the glass element over a measuring path of 4 mm is at least 0.1 μm.

78. The glass element of claim 77, wherein a ratio LTVₘᵢₙ/LTVₘₐₓ is in a range of from 1:50 to 1:1.

79. The glass element of claim 68, wherein the glass element has a length in a range of from 10 mm to 500 mm and/or a width in a range of from 5 mm to 400 mm, wherein a ratio of the length and the width is at least 1:1.

80. The glass element of claim 68, wherein the glass element has a wedge-shaped thickness profile.

81. The glass element of claim 68, wherein a surface roughness Ra at the first surface and/or at the second surface is at most 0.80 nm.

82. The glass element of claim 68, wherein the glass element comprises at least one impact resistant region characterized by an impact resistance corresponding to a normalized pen drop height of at least 2.0 per μm.

83. The glass element of claim 82, wherein the at least one impact resistant region is characterized by an impact resistance corresponding to a pen drop height of at least 5 mm.

84. The glass element of claim 68, wherein the glass element comprises at least one flexible region characterized by a ball-on-ring failure force of at least 5.0 N and/or by a 2-point bending strength of at least 1300 MPa.

85. The glass element of claim 68, wherein the glass element comprises at least one edge connecting the first surface and the second surface; wherein the at least one edge has a chamfer structure comprising three surfaces, wherein the three surfaces comprises a third surface, a primary connecting surface connecting the third surface and the first surface, and a secondary connecting surface connecting the third surface and the second surface; wherein the chamfer structure has a profile such that a tangent line A to the primary connecting surface crosses a tangent line B to the first surface at a distance d₁ from a tangent line C to the third surface and a tangent line D to the secondary connecting surface crosses a tangent line E to the second surface at a distance d₂ from the tangent line C to the third surface, wherein both d₁ and d₂ are measured perpendicular to the tangent line C to the third surface, wherein the tangent lines A, B, C, D, and E are obtained by fitting a respective tangent line to the corresponding surface in the profile of the chamfer structure.

86. A stack assembly, comprising:
a glass element having a first surface and a second surface, wherein the glass element is characterized by the following thickness profile:
the glass element has a minimum thickness tₘᵢₙ and a maximum thickness tₘₐₓ, wherein tₘᵢₙ is at least 10 μm and tₘₐₓ is at most 400 μm, a total thickness variation (TTV) of the glass element is in a range of from 10 μm to 390 μm, and a maximum local thickness variation (LTVₘₐₓ) of the glass element over a measuring path of 4 mm is at most 69 μm;
wherein the stack assembly is characterized by not having optical distortion and/or by an absence of failure when the stack assembly is held for 60 minutes at a bending radius R of 5.0 mm at the center of a flexible region of the glass element; and
an index-matched filler in a maximum thickness of less than 20 μm, wherein the index-matched filler has a refractive index n_{d} that deviates from a refractive index n_{d} of the glass element by at most 0.01.

87. A method for producing a glass element having a first surface and a second surface and characterized by the following thickness profile: the glass element has a minimum thickness tₘᵢₙ and a maximum thickness tₘₐₓ, wherein tₘᵢₙ is at least 10 μm and tₘₐₓ is at most 400 μm, a total thickness variation (TTV) of the glass element is in a range of from 10 μm to 390 μm, and a maximum local thickness variation (LTVₘₐₓ) of the glass element over a measuring path of 4 mm is at most 69 μm, the method comprising at least one of the following:
hot-forming a glass melt via slit down draw including nozzle contours adjusted to the thickness profile of the glass element;
hot-forming a glass melt via overflow down draw including a tilted overflow trough or an overflow trough with a height level profile adjusted to the thickness profile of the glass element;
hot-forming via redraw of a starting glass article adjusted to the thickness profile of the glass element;
hot-pressing or heating a starting glass article on a tilted surface;
etching a starting glass article to the desired thickness profile; or
mechanically grinding and/or polishing a starting glass article to the desired thickness profile.
